(19) United States
(12) Patent Application Publication
(10) Pub. No.: US 2026/0080566 A1
(43) Pub. Date: Mar. 19, 2026

(54) OBJECT DETECTION USING IMAGE PAIRS FOR AUTONOMOUS OR SEMI-AUTONOMOUS SYSTEMS AND APPLICATIONS

(71) Applicant: NVIDIA Corporation, Santa Clara, CA (US)

(72) Inventors: Andreas Klaus, Graz (AT); Joachim Bauer, Thal (AT); Gerald Schweighofer, Feistritztal (AT); Joachim Pehserl, Lynnwood, WA (US)

(21) Appl. No.: 18/886,488

(22) Filed: Sep. 16, 2024

(51) Int. Cl. G06T 7/73; G06T 7/246; G06T 7/55; G06T 15/20

(52) U.S. Cl. CPC G06T 7/74; G06T 7/248; G06T 7/55; G06T 15/20; G06T 2207/10012; G06T 2207/10028; G06T 2207/10044; G06T 2207/20212; G06T 2207/30252

(57) ABSTRACT

In various examples, optical flow-based algorithms may be used to detect objects in an environment by computing displacement fields for images captured using asynchronous cameras. As an example, an asynchronous set of cameras (e.g., two or more cameras) may capture a series of asynchronous images of an environment. Additionally, in some examples, the cameras may be positioned at different locations and capture different fields of view of the environment. Based at least on the differing image capture times and/or the differing fields of view of the images, image pixels corresponding to the same, physical locations in the environment may move locations between images of the series of images. The disclosed systems and methods may use optical flow algorithms to compute scores associated with the displacement/movement of the pixels throughout the series of images, as well as use these scores to detect objects in the environment.

### BACKGROUND

Effectively perceiving a surrounding environment is an essential element for various autonomous or semi-autonomous functionalities and tasks. In various instances, perception techniques may rely on a combination of sensors—such as cameras, LiDARs, RADARs, and/or ultrasonic sensors—to collect data from the environment. This sensor data may then be processed using advanced algorithms and/or artificial intelligence to identify objects, detect obstacles, assess traffic conditions, among other operations. Through this complex process, autonomous or semi-autonomous vehicles or machines may be able to navigate safely, make situational-specific decisions, and avoid collisions.

In some instances, to avoid collisions with objects, perception systems may need to detect objects quickly and reliably to allow autonomous or semi-autonomous systems to initiate collision avoidance operations, such as lane changes, braking, and/or any other maneuvers. For example, in highway scenarios where vehicles may be traveling at speeds of 60-80 MPH, or even more, minimum detection distances may be in a range of 120-150 meters from the vehicle to allow enough time for autonomous or semi-autonomous systems to safely avoid collisions. However, detecting certain objects at those ranges can be challenging. For instance, small or low-lying objects (e.g., debris, potholes, etc.) may be difficult to detect—especially at long range—as sensor data for those objects may be limited.

### SUMMARY

Embodiments of the present disclosure relate to object detection using (e.g., asynchronous) image pairs for autonomous or semi-autonomous systems and applications. For instance, systems and methods described herein may detect objects in an environment using optical flow-based algorithms (which may execute using one or more optical flow hardware accelerators) to compute displacement fields for images captured using asynchronous cameras. As an example, an asynchronous set of cameras (e.g., two or more cameras) may capture a series of asynchronous images of an environment. Additionally, in some examples, the cameras may be positioned at different locations and capture different fields of view of the environment. Based at least on the differing image capture times and/or the differing fields of view of the images, image pixels corresponding to the same, physical locations in the environment may move locations between images of the series of images. The disclosed systems and methods may use optical flow algorithms (and/or other motion compensation or tracking algorithms) to compute scores associated with the displacement/movement of the pixels throughout the series of images, as well as use these scores to detect objects in the environment.

In contrast to conventional systems, the systems of the present disclosure, in some embodiments, are able to reliably detect low-lying (e.g., low to ground, short, small, etc.) objects and/or features at various ranges—including close ranges, extended ranges, or any ranges in between—such that autonomous or semi-autonomous systems may have enough time to initiate operations to avoid colliding with the low-lying objects, or any other type or size of objects or features (e.g., potholes, debris, etc.). For instance, by using a series of alternating, asynchronous images to form approximate stereo pairs, the systems of the present disclosure are able to enhance stereo baselines orthogonal to a driving direction of autonomous or semi-autonomous machines. By enhancing the stereo baselines using the alternating, asynchronous images, the systems of the present disclosure are able to detect objects—even small or low-lying objects—and approximate locations of the objects at greater distances than conventional systems. This allows the autonomous and semi-autonomous machines to have increased decision times to perform operations to avoid collisions with the objects and/or features. Additionally, by using the series of alternating, asynchronous images, the systems of the present disclosure are able to reduce system bandwidth by using image frames multiple times and/or achieve greater frame rates by staggering sensor triggers—e.g., because stereo image pairs from a synchronized stereo camera are not required.

### BRIEF DESCRIPTION OF THE DRAWINGS

The present systems and methods for object detection using (e.g., asynchronous) image pairs for autonomous or semi-autonomous systems and applications are described in detail below with reference to the attached drawing figures, wherein:

FIG. 1 is a data flow diagram illustrating an example of a process for detecting objects using asynchronous images to form approximate stereo pairs, in accordance with some embodiments of the present disclosure;

FIG. 2 illustrates a visualization of an example of using asynchronous, alternating images to form approximate stereo pairs for object detection, in accordance with some embodiments of the present disclosure;

FIGS. 3A and 3B illustrate examples of images generated using different sensors of an approximate stereo pair, in accordance with some embodiments of the present disclosure;

FIG. 3C illustrates an example of displacements of the objects between the different images generated using the different sensors, in accordance with some embodiments of the present disclosure;

FIG. 3D illustrates an example of a relationship between depth/distance and apparent disparity, in accordance with some embodiments of the present disclosure;

FIG. 3E illustrates an example visualization of using the relationship explained in the example of FIG. 3D to detect the presence of objects in an environment, in accordance with some embodiments of the present disclosure;

FIG. 4 is a data flow diagram illustrating an example of an optical flow process for refining disparity images, in accordance with some embodiments of the present disclosure;

FIG. 5 is a data flow diagram illustrating an example of a process for training one or more machine learning models to detect objects using asynchronous, alternating images, in accordance with some embodiments of the present disclosure;

FIG. 6 illustrates an example of a system that may perform one or more of the processes described herein, in accordance with some embodiments of the present disclosure;

FIG. 7 is a flow diagram illustrating an example of a method for controlling operations of a vehicle based at least on detecting objects in an environment using asynchronous images, in accordance with some embodiments of the present disclosure;

FIG. 8 is a flow diagram illustrating an example of a method for determining object locations in an environment using an asynchronous series of frames of sensor data, in accordance with some embodiments of the present disclosure;

FIG. 9A is an illustration of an example autonomous vehicle, in accordance with some embodiments of the present disclosure;

FIG. 9B is an example of camera locations and fields of view for the example autonomous vehicle of FIG. 9A, in accordance with some embodiments of the present disclosure;

FIG. 9C is a block diagram of an example system architecture for the example autonomous vehicle of FIG. 9A, in accordance with some embodiments of the present disclosure;

FIG. 9D is a system diagram for communication between cloud-based server(s) and the example autonomous vehicle of FIG. 9A, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

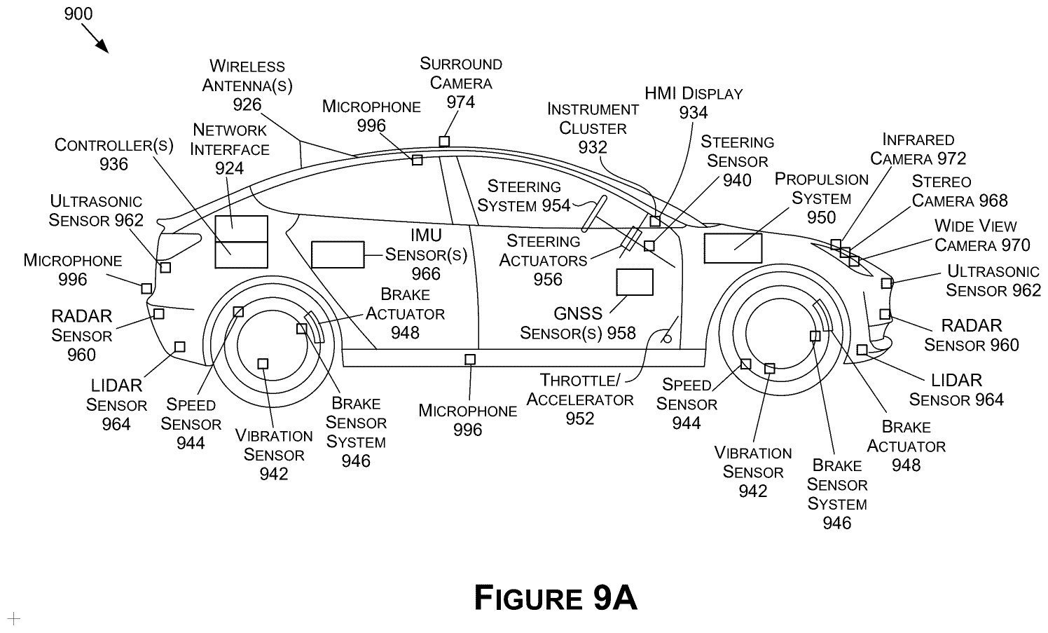

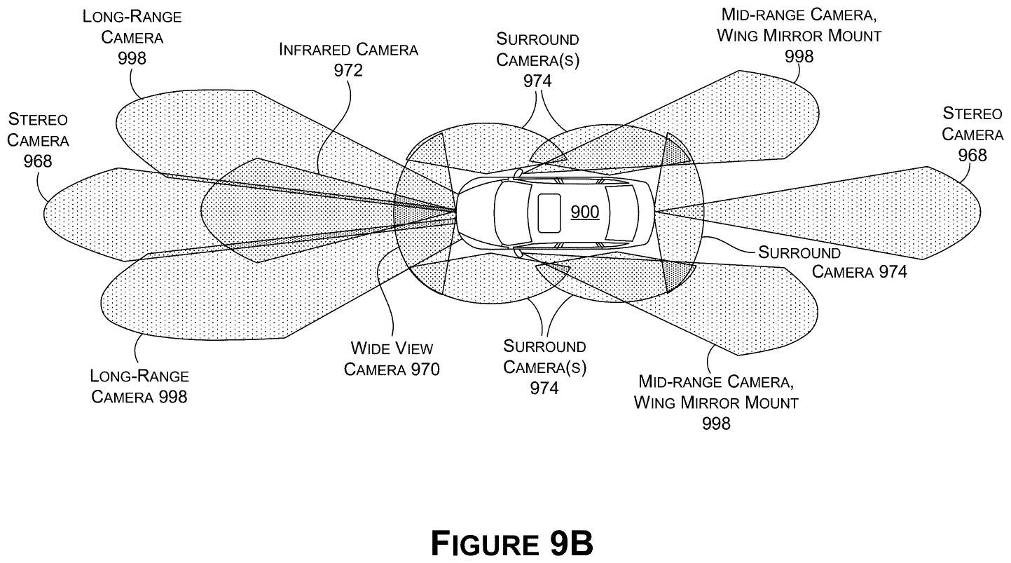

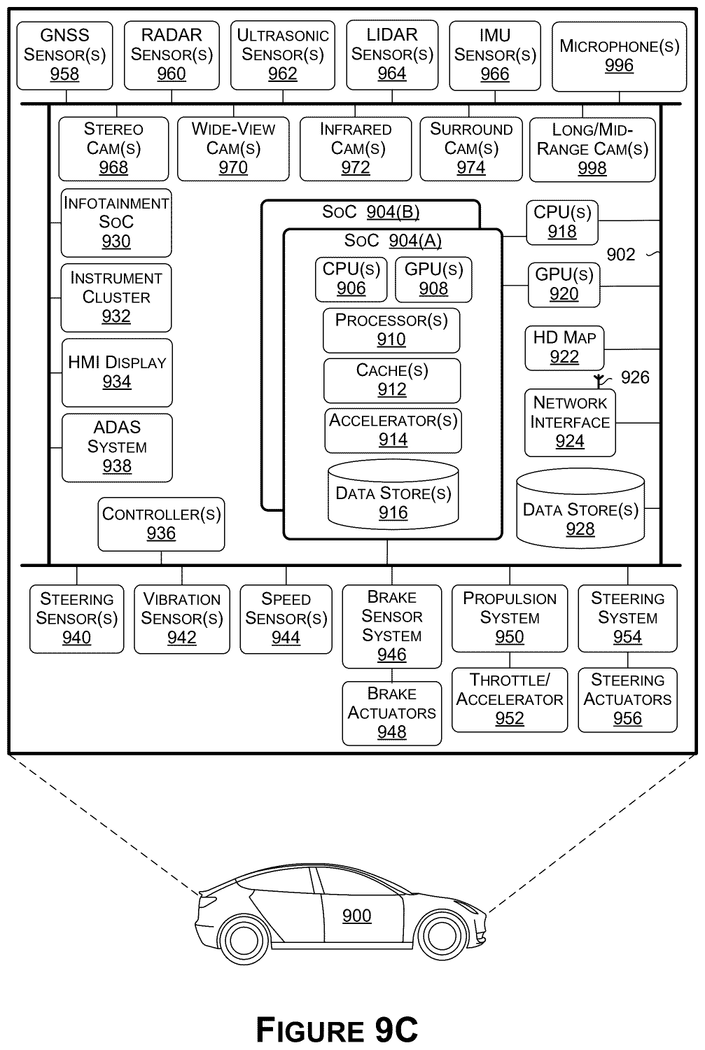

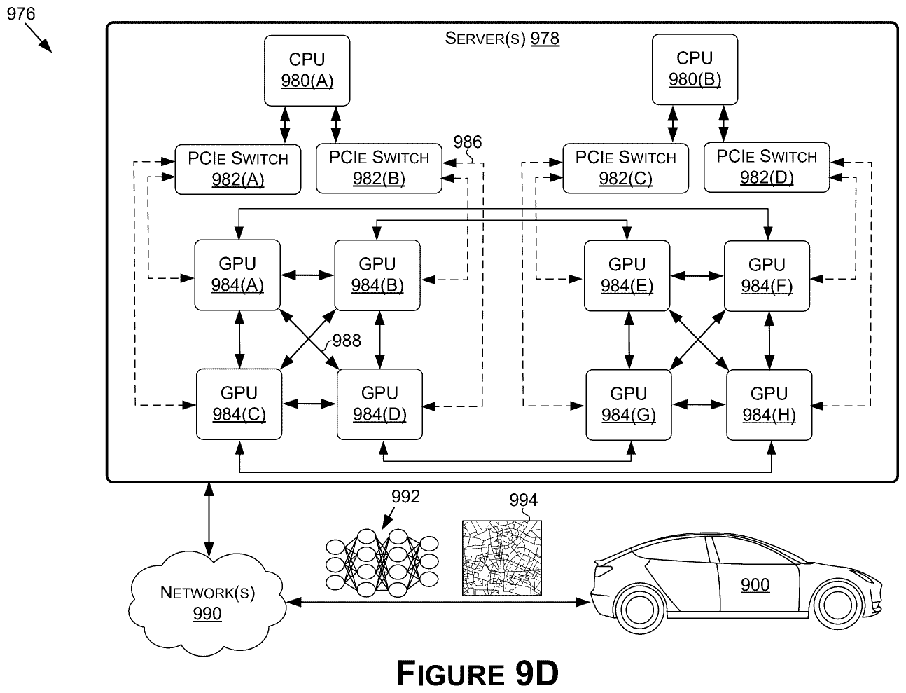

Systems and methods are disclosed related to object detection using asynchronous image pairs for autonomous or semi-autonomous systems and applications. Although the present disclosure may be described with respect to an example autonomous or semi-autonomous vehicle or machine 900 (alternatively referred to herein as “vehicle 900,” “ego-vehicle 900,” “ego-machine 900,” or “machine 900,” an example of which is described with respect to FIGS. 9A-9D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to detecting objects in the context of autonomous and semi-autonomous vehicle applications, this is not intended to be limiting, and the systems and methods described herein may be used in augmented reality, virtual reality, mixed reality, robotics, security and surveillance, autonomous or semi-autonomous machine applications, and/or any other technology spaces where object detection may be used.

For instance, a system(s) may receive an asynchronous series of frames of sensor data generated using asynchronous sensors of a machine navigating within an environment. As described herein, the sensor data may include, but is not limited to, LiDAR data generated using one or more LiDAR sensors, image data generated using one or more image sensors (e.g., one or more cameras), RADAR data generated using one or more RADAR sensors, ultrasonic data generating using one or more ultrasonic sensors, and/or any other type of sensor data generated using any other type of sensor. In some examples, one or more of the asynchronous sensors may be positioned at different locations with respect to the machine and, as such, may capture different (at least partially overlapping) fields of view and/or sensory fields of the environment. Based at least on the asynchronous frames and/or the differing fields of view/sensory fields of the sensors, points (e.g., measurements, returns, pixels, etc.) in the sensor data frames that correspond to the same, physical locations in the environment may “move” locations between frames of the series of frames. The system(s) may use one or more optical flow-based algorithms (and/or other motion compensation or tracking algorithms) to compute displacement scores associated with the displacement/movement of the points throughout the series of frames, as well as use these scores to detect objects in the environment.

For instance, and for an asynchronous pair of images captured using an asynchronous pair of cameras of a machine, the system(s) may use the asynchronous pair of images to detect and/or determine locations of objects in an environment depicted in the pair of images. In some examples, the asynchronous pair of cameras may generate a temporal series of images that includes alternating images from the asynchronous pair of cameras. As an example, a first camera of the pair of cameras may generate a first series of images depicting the environment, and a second camera of the pair of cameras may generate a second series of images depicting the environment. The system(s) may generate the temporal series of images using a first alternating series of images from the first series of images and a second alternating series of images from the second series of images that is offset from the first alternating series of images. For instance, if both of the first and the second series of images includes ten frames numbered 1-10, the temporal series of images may include the odd numbered frames (e.g., frames 1, 3, 5, 7, and 9) of the first series of images and the even numbered frames (e.g., frames 2, 4, 6, 8, and 10) of the second series of images.

As described herein, in some instances the system(s) may use the temporal series of alternating images to form approximate stereo pairs, and evaluate the stereo pairs to detect objects in the environment. For instance, and continuing the example from above, the system(s) may form a first approximate stereo pair of images using the first frame (e.g., frame 1) of the first series of images and the second frame (e.g., frame 2) of the second series of images, form a second approximate stereo pair of images using the second frame of the second series of images and the third frame (e.g., frame 3) of the first series of images, form a third approximate stereo pair of images using the third frame of the first series of images and the fourth frame (e.g., frame 4) of the second series of images, and so forth.

Although described herein as using a temporal series of images to detect objects, this is not intended to be limiting. The system(s) of the present disclosure may process and evaluate the images of the temporal series of images—as well as form the approximate stereo pairs and use them to make object predictions—in real time or near real time. In other words, while the images captured by the asynchronous pair of cameras may eventually form a temporal series of images that combine a first alternating series of images and a second alternating series of images offset from the first alternating series, the system(s) of the present disclosure may form and analyze approximate images pairs while (e.g., as a part of) the temporal series of images is being generated.

In various examples, the first camera may be associated with a first field of view and the second camera may be associated with a second field of view based at least on the positioning of the cameras with respect to the machine. For instance, the first camera may be disposed at a first location of the machine (e.g., left side) and the second camera may be disposed at a second location of the machine (e.g., right side). In some examples, the first location and the second location may be horizontally displaced from one another while having minimal (e.g., none or at least some) vertical displacement. Alternatively, the first location and the second location may be vertically displaced from one another while having minimal horizontal displacement. In this way, the approximate stereo pairs of images may include different images that depict the environment from different perspectives. By using alternating images, the system(s) may enhance stereo baselines orthogonal to the driving direction of the machine.

In some examples, because the first camera and the second camera are asynchronous (e.g., not synchronized with respect to at least one of field of view/sensor field or frame capture time/cadence), their image capture times may differ. That is, first images of the first series of images may be associated with first timestamps (indicating each image's respective capture time), while second images of the second series of images may be associated with second timestamps, which may be different from the first timestamps (e.g., correspond to different instances of time). Additionally, or alternatively, and since the cameras are asynchronous, in at least some instances the first timestamps and the second timestamps may be the same or correspond to the same instance of time, even though the cameras may not be intentionally synchronized.

In some instances, the system(s) may perform one or more correspondence estimation steps to identify image locations in the approximate stereo pairs of images that depict the same physical locations in the environment and/or the observed scene. For instance, the system(s) may use optical flow estimation to determine first points or pixels in the first image of the approximate stereo pair and second points or pixels in the second image of the approximate stereo pair that correspond to the same locations, objects, or features in the environment or scene. To overcome any limited convergence radius of the optical flow-based correspondence estimation, in some examples, the system(s) may use a hierarchical search in an image pyramid. This hierarchical search in the image pyramid may allow the system(s) to estimate dense flow fields for asynchronous image pairs that only approximately form a stereo pair.

As described herein, to detect objects in the environment and/or approximate their locations, the system(s) may, in some examples, compute disparity scores (also referred to herein as “displacement scores”) for one or more points (e.g., pixels or groups of pixels) of the asynchronous image pairs. The disparity scores may indicate magnitudes in movement of the pixels between images of the image pairs. For instance, and for an image pair that includes a first image from a first camera and a second image from a second camera, a disparity score may indicate an amount in which a pixel value corresponding to a specific point in the environment moved between a first pixel location in the first image to a second pixel location in the second image.

In some examples, the system(s) may assume that objects exhibit a measurable difference in the x-parallax (also referred to herein as “displacement” or “disparity”) when compared to disparity scores of a driving surface or other, relatively smooth surface. As such, the system(s) may, in some instances, compute object detection scores for each point (e.g., pixel or group of pixels) of the image pairs by comparing the point's disparity value with those of adjacent points in image rows (e.g., pixel rows) above and/or below. Because disparity decreases as range increases, if the decrease in disparity score is less than the disparity decrease observed in the rest of the environment surrounding an object, the detection score may be set to the difference. In some examples, the typical disparity decrease may be defined either as an input parameter or automatically derived by estimating the ground surface.

In some examples, the system(s) may smooth the disparity scores by applying one or more filters. For instance, the system(s) may apply a Gaussian filter, a median filter, or any other type of filter to the disparity scores to smooth the disparity scores and provide reliable data. Additionally, in some examples, the system(s) may use temporal fusion to further enhance the accuracy and robustness for detecting objects. The temporal fusion may, in some instances, leverage the derived optical flow to ascertain the position and corresponding detection score from preceding image pairs. The system(s) may use incremental update schemas and trigger detections when the detection score surpasses a threshold.

As described herein, the system(s) may, in some examples, detect the presence of objects in the environment based at least on the disparity scores for image pixels corresponding to those objects meeting or exceeding a threshold, or decreasing less than surrounding image pixels corresponding to a driving surface. In some examples, the system(s) may estimate the locations of the objects based on the disparity scores and/or the locations of the pixels. For instance, image pixels that are closer to the bottom of an image frame and correspond to an object may be closer to the machine than image pixels that are closer to the middle and/or top of the image frame. Additionally, greater disparity scores may correspond to objects that are closer to the machine than smaller disparity scores, as disparity may decrease as range from the sensors/machine increases.

In some examples, the system(s) may perform one or more operations associated with the machine based at least on detecting objects in the environment and/or determining the locations of the object using the techniques disclosed herein. For instance, the system(s) may cause the machine to perform one or more collision avoidance operations to avoid collisions with the objects. Such operations may include, but are not limited to, changing lanes, decreasing speed, coming to a stop, or performing machine to machine or machine to human communication operations (e.g., honking a horn, flashing lights, using turn signals, etc.).

In some embodiments, the systems and methods described herein may be performed within a simulation environment (e.g., NVIDIA's DriveSIM) using simulated data (e.g., simulated sensor data of simulated sensors of a virtual or simulated machine). For example, simulated sensor data may be used to compute disparity scores and detect simulated objects within the simulation environment, and this information may be used to perform operations (e.g., collision avoidance operations or any other driving-related operations) associated with the virtual machine within the environment. These simulated operations may be used to test performance of the underlying algorithms, systems, and/or processes prior to deploying them in the real-world. In some instances, the simulation may be used to generate synthetic training data—e.g., training data including asynchronous pairs of sensor frames and/or disparity scores associated therewith from within the simulation. The synthetic training data (in addition to or alternatively from real-world data) may then be processed to determine locations of the objects in the environment, such as locations of items within a warehouse, for example. In any example, such as where a simulation environment is used for testing, validation, training, etc., the simulation environment and/or associated training data may be rendered or otherwise generated using one or more light transport algorithms—such as ray-tracing and/or path-tracing algorithms.

In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to identify objects and/or features, etc. that may be included in a visualization or mapping of an environment to aid a remote operator in controlling—or providing waypoints or other indications of control or navigation—an autonomous or semi-autonomous machine through an environment. For example, the low-lying or small objects/features identified using the systems and methods described herein may be included in a visualization and/or otherwise identified to a remote operator to aid the remote operator in avoiding the objects/features during remote control.

In some examples, machine learning models, optical flow algorithms, and/or other algorithms or processes described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model (e.g., weights and biases). In some instances, such as where the machine learning model/algorithm is small enough (e.g., has a small enough number of parameters/code), the model/algorithm may be included within the container itself. In some examples—such as where the model/algorithms is large—the model may be hosted/stored in the cloud (e.g., in a data center) and/or may be hosted on-premises (e.g., using a server at a warehouse in communication with one or more robots) and/or at the edge (e.g., on the vehicle, but outside of the container). In such embodiments, the models/algorithms may be accessible via one or more APIs—such as REST APIs. As such, and in some embodiments, the machine learning models/algorithms described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s)/algorithm(s) (e.g., that has been optimized for high performance inference), an inference runtime software to execute the machine learning model(s) and provide outputs/responses to inputs (e.g., user queries, prompts, sensor data, etc.), and enterprise management software to provide health checks, identity, and/or other monitoring. In some embodiments, the inference microservice may include software to perform in-place replacement and/or updating to the machine learning model(s) and/or algorithm(s). When replacing or updating, the software that performs the replacement/updating may maintain user configurations of the inference runtime software and enterprise management software.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

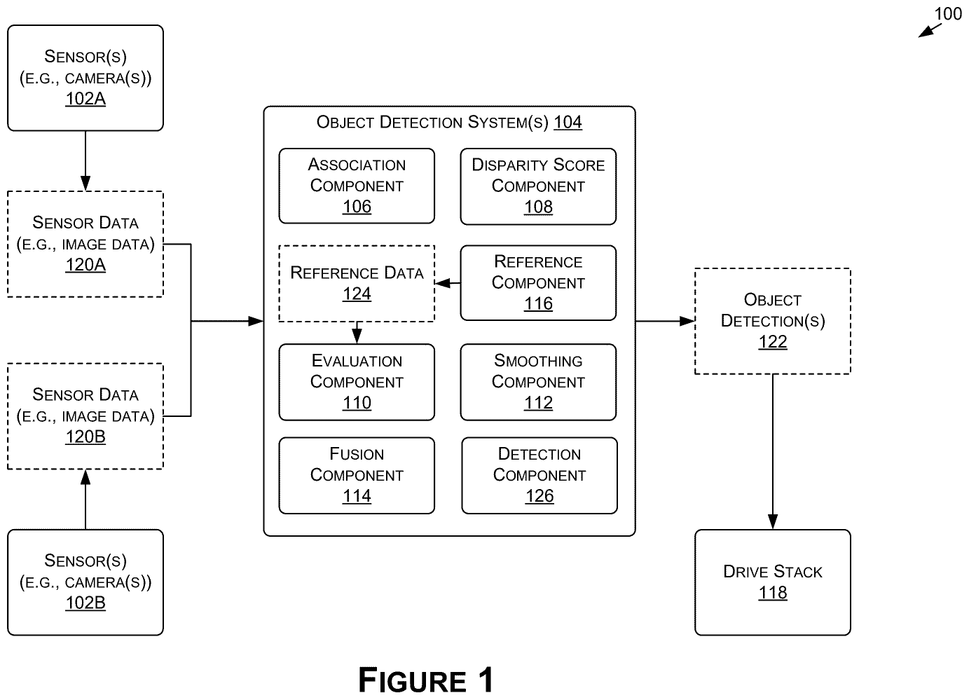

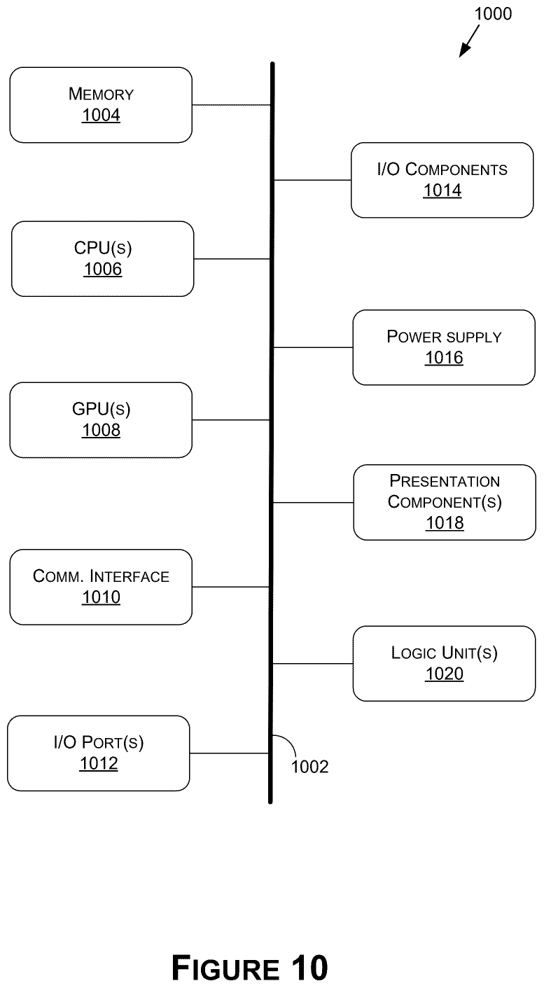

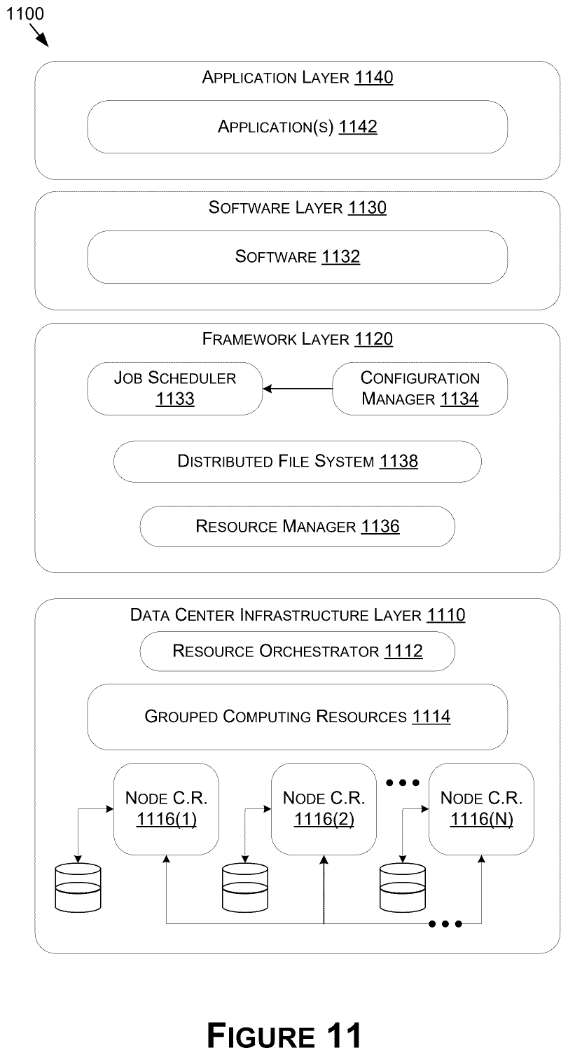

With reference to FIG. 1, FIG. 1 is a data flow diagram illustrating an example of a process for detecting objects using asynchronous images to form approximate stereo pairs, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 900 of FIGS. 9A-9D, example computing device 1000 of FIG. 10, and/or example data center 1100 of FIG. 11.

The process 100 may be implemented using, amongst additional or alternative components, one or more sensors, such as a first sensor(s) 102A and a second sensor(s) 102B (also referred to herein collectively as “sensors 102”), an object detection system(s) 104, which may include an association component 106, a disparity score component 108, an evaluation component 110, a smoothing component 112, and/or a fusion component 114, a disparity reference component 116, and a drive stack 118.

As an overview, the first sensor(s) 102A may generate first sensor data 120A and the second sensor(s) 102B may generate second sensor data 120B, and the first sensor data 120A and the second sensor data 120B (also referred to herein collectively as “sensor data 120”) may be applied to the object detection system(s) 104. The object detection system(s) 104 may—using one or more of the association component 106, the disparity component 108, the evaluation component 110, the smoothing component 112, and/or the fusion component 114—generate data representing an object detection(s) 122 based at least on the sensor data 120. For instance, the association component 106 may determine associations between the first sensor data 120 and the second sensor data 120B (e.g., points in the sensor data that correspond to the same locations in an environment). The disparity score component 108 may compute disparity scores for one or more points of the sensor data 120 based on the associations. The evaluation component 110 may evaluate the disparity scores relative to a baseline disparity score(s) indicated in reference data 124 generated by the reference component 116, and compute detection scores indicative of whether points in the sensor data 120 correspond to objects in the environment. The smoothing component 112 may smooth the detection scores by applying one or more filters and the fusion components 114 may further refine the detection scores using temporal fusion (e.g., based on previous detection scores). The object detection system(s) 104 may output the object detection(s) 122 based on the refined detection scores, and the drive stack 118 may use the object detection(s) 122 to perform one or more operations, such as operations associated with the machine 900 described herein.

In one or more embodiments, the sensors 102 may include at least one of one or more physical sensors in a physical environment or one or more virtual sensors in a simulated environment. For example, the one or more sensors 102 may correspond to a physical or simulated version of the vehicle or machine 900, as described herein, or another machine and/or robot. In at least one example, one or both of the sensors 102 (e.g., the first sensor 102A and/or the second sensor 102B) may correspond to a camera(s) and one or more of the sensor data 120 (e.g., the first sensor data 120A and/or the second sensor data 120B) may correspond to image data representing images.

In various examples, the sensor data 120 may include, without limitation, sensor data from any of the sensors of the vehicle or machine 900 (and/or other vehicles or objects, such as robotic devices, VR systems, AR systems, etc., in some examples). For example, and with reference to FIGS. 9A-9C, the sensor data 120 may include data generated by or using, without limitation, global navigation satellite systems (GNSS) sensor(s) 958 (e.g., Global Positioning System sensor(s), differential GPS (DGPS), etc.), RADAR sensor(s) 960, ultrasonic sensor(s) 962, LIDAR sensor(s) 964, inertial measurement unit (IMU) sensor(s) 966 (e.g., accelerometer(s), gyroscope(s), magnetic compass(es), magnetometer(s), etc.), microphone(s) 996, stereo camera(s) 968, wide-view camera(s) 990 (e.g., fisheye cameras), infrared camera(s) 972, surround camera(s) 974 (e.g., 360 degree cameras), long-range and/or mid-range camera(s) 998, speed sensor(s) 944 (e.g., for measuring the speed of the vehicle 900 and/or distance traveled), and/or other sensor types.

In some examples, the sensor data 120 may include sensor data generated using one or more forward-facing sensors, side-view sensors, downward-facing sensors, upward-facing sensors, and/or rear-view sensors. This sensor data 120 may be useful for identifying, detecting, classifying, and/or tracking movement of objects, features, etc. around the vehicle 900 within the environment. In embodiments, any number of the sensors 102 may be used to incorporate multiple fields of view (e.g., the fields of view of the long-range cameras 998, the forward-facing stereo camera 968, and/or the forward facing wide-view camera(s) 990 of FIG. 9B) and/or sensory fields (e.g., of a LIDAR sensor 964, a RADAR sensor 960, etc.). As used herein, the sensor data 120 or portions of sensor data may reference unprocessed sensor data, pre-processed sensor data, or a combination thereof.

The sensor data 120 may include image data representing an image(s), image data representing a video (e.g., snapshots of video), data representing sensory fields of sensors (e.g., depth maps for LIDAR sensors, a value graph for ultrasonic sensors, etc.), and/or data representing measurements of sensors. Where the sensor data 120 includes image data, any type of image data format may be used, such as, for example and without limitation, compressed images such as in Joint Photographic Experts Group (JPEG) or Luminance/Chrominance (YUV) formats, compressed images as frames stemming from a compressed video format such as H.264/Advanced Video Coding (AVC) or H.265/High Efficiency Video Coding (HEVC), raw images such as originating from Red Clear Blue (RCCB), Red Clear (RCCC), or other type of imaging sensor, and/or other formats. In addition, in some examples, the sensor data 120 may be used without any pre-processing (e.g., in a raw or captured format), while in other examples, at least some of the sensor data 120 may undergo pre-processing (e.g., noise balancing, demosaicing, scaling, cropping, augmentation, white balancing, tone curve adjustment, etc., such as using a sensor data pre-processor (not shown)).

For instance, in some examples, the sensor data 120 may be captured in one format (e.g., RCCB, RCCC, RBGC, etc.), and then converted (e.g., during pre-processing of the sensor data) to another format. In some other examples, the sensor data 120 may be provided as input to a sensor data or image data pre-processor (not shown) to generate pre-processed image data. Many types of images or formats may be used as inputs; for example, compressed images such as in Joint Photographic Experts Group (JPEG), Red Green Blue (RGB), or Luminance/Chrominance (YUV) formats, compressed images as frames stemming from a compressed video format (e.g., H.264/Advanced Video Coding (AVC), H.265/High Efficiency Video Coding (HEVC), VP8, VP9, Alliance for Open Media Video 1 (AV1), Versatile Video Coding (VVC), or any other video compression standard), raw images such as originating from Red Clear Blue (RCCB), Red Clear (RCCC) or other type of imaging sensor. In some examples, different formats and/or resolutions of the sensor data 120 could be used for different tasks.

A sensor data or image data pre-processor may use data representative of one or more images (or other data representations, such as LiDAR depth maps) and load the sensor data into memory in the form of a multi-dimensional array/matrix (alternatively referred to as tensor, or more specifically an input tensor, in some examples). The array size may be computed and/or represented as W×H×C, where W stands for the image width in pixels, H stands for the height in pixels, and C stands for the number of color channels. Without loss of generality, other types and orderings of input image components are also possible. In some embodiments, batching may be used for training and/or for inference. In such examples, the batch size B may be used as a dimension (e.g., an additional fourth dimension). Thus, the input tensor may represent an array of dimension W×H×C×B. Any ordering of the dimensions may be possible, which may depend on the particular hardware and software used to implement the sensor data or image data pre-processor. This ordering may be chosen to maximize training and/or inference performance of neural networks and/or other machine learning models, in some instances.

In some embodiments, a pre-processing image pipeline may be employed by the sensor data or image data pre-processor to process a raw image(s) acquired by a sensor(s) (e.g., sensors 102) and included in the sensor data 120 to produce pre-processed image data or sensor data which may represent an input image(s) to object detection system(s) 104. An example of a suitable pre-processing image pipeline may use a raw RCCB Bayer (e.g., 1-channel) type of image from the sensor and convert that image to a RCB (e.g., 3-channel) planar image stored in Fixed Precision (e.g., 16-bit-per-channel) format. The pre-processing image pipeline may include decompanding, noise reduction, demosaicing, white balancing, histogram computing, and/or adaptive global tone mapping (e.g., in that order, or in an alternative order).

Where noise reduction is employed by the image data pre-processor, it may include bilateral denoising in the Bayer domain. Where demosaicing is employed by the image data pre-processor, it may include bilinear interpolation. Where histogram computing is employed by the sensor data or image data pre-processor, it may involve computing a histogram for the C channel, and may be merged with the decompanding or noise reduction in some examples. Where adaptive global tone mapping is employed by the sensor data or image data pre-processor, it may include performing an adaptive gamma-log transform. This may include calculating a histogram, getting a mid-tone level, and/or estimating a maximum luminance with the mid-tone level.

In the example of FIG. 1, the sensors 102 include cameras and the sensor data 120 represents images (e.g., image frames) corresponding to perspective views of the cameras mounted to the vehicle 900, examples of which are described herein. Each camera and/or view may provide one or more images for input to the object detection system(s) 104. For example, FIG. 1 shows a non-limiting example where there is a pair of cameras (e.g., the first sensor(s) 102A and the second sensor(s) 102B) that may each capture a series of images depicting the environment from different views or perspectives (e.g., fields of view). As described herein, the object detection system(s) 104 may receive the sensor data 120 from the sensors 102, and use the sensor data 120 to form approximate stereo pairs of images by pairing alternating frames of each sensor 102, thereby enhancing stereo baselines orthogonal to the driving direction of the machine.

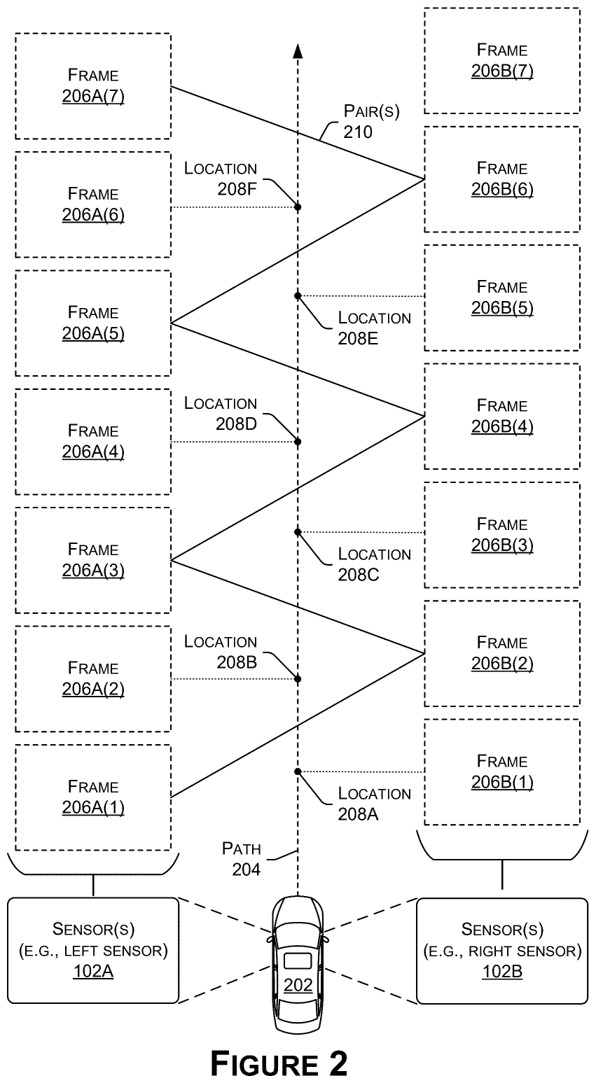

For instance, FIG. 2 illustrates a visualization of an example of using asynchronous, alternating images to form approximate stereo pairs for object detection, in accordance with some embodiments of the present disclosure. As shown in the example of FIG. 2, a machine 202 (which may correspond to the machine 900) may include the first sensor(s) 102A and the second sensor(s) 102B, which may correspond to a left sensor(s) and a right sensor(s), respectively. That is, the first sensor(s) 102A may be disposed or positioned on a left side of the machine 202 and the second sensor(s) 102B may be disposed or positioned on a right side of the machine 202.

As the machine 202 proceeds to move along a path 204, the machine 202 may use the first sensor(s) 102A and the second sensor(s) 102B to generate one or more frames of sensor data (e.g., image frames). For instance, the first sensor(s) 102A may generate a first series of frames 206A(1)-206A(7) and the second sensors 102B may generate a second series of frames 206B(1)-206B(7). The individual frames of the first and second series of frames may each be captured at respective instances of time. For instance, each frame of the first and second series of frames may be captured when the machine 202 is positioned at various locations 208A-208F along the path 204, and those locations may correspond to specific instances of times or timestamps associated with the capture time of the frames. As an example, the first frame 206B(1) of the second series of frames may be captured when the machine 202 is positioned at the first location 208A along the path 204, the second frame 206A(2) of the first series of frames may be captured when the machine 202 is positioned at the second location 208B along the path 204, the third frame 206B(3) of the second series of frames may be captured when the machine 202 is positioned at the third location 208C along the path 204, and so forth.

As shown, in FIG. 2, the capture times associated with the first series of frames 206A(1)-(7) generated using the first sensor(s) 102A of the machine 202 may be offset from the capture times associated with the second series of frames 206B(1)-(7) generated using the second sensor(s) 102B of the machine 202. In some instances, the first sensor(s) 102A and the second sensor(s) 102B may be unsynchronized, as described herein, so the capture times of the frames may all be different. However, the object detection system(s) 104 may use the unsynchronized frames to form approximate stereo pairs by pairing alternating frames of each sensor 102. For instance, the diagonal lines connecting alternating frames 206A of the first series to alternating frames 206B of the second series may represent one or more pairs 210 (e.g., approximate stereo pairs) of the frames. For example, the first frame 206A(1) of the first series may form a first pair with the second frame 206B(2) of the second series, the second frame 206B(2) of the second series may form a second pair with the third frame 206A(3) of the first series, the third frame 206A(3) of the first series may form a third pair with the fourth frame 206B(4) of the second series, and so forth. The object detection system(s) 104 may use these pairs to compute point or pixel disparity scores between the frames (e.g., between a left sensor frame and a right sensor frame of a pair of frames).

Referring back to the example of FIG. 1, the process 100 may include the object detection system(s) 104 obtaining the sensor data 120 from the sensors 102. For instance, the object detection system(s) 104 may obtain first data representing a first image frame from a first camera and second data representing a second image frame from a second camera. The first image frame and the second image frame may be used to form an approximate stereo pair of images. For instance, the first camera and the second camera may not be synchronized, so the first image frame and the second image frame may form an asynchronous pair of images associated with different timestamps. The image frames may depict the environment from different perspectives or otherwise capture different fields of view of the environment.

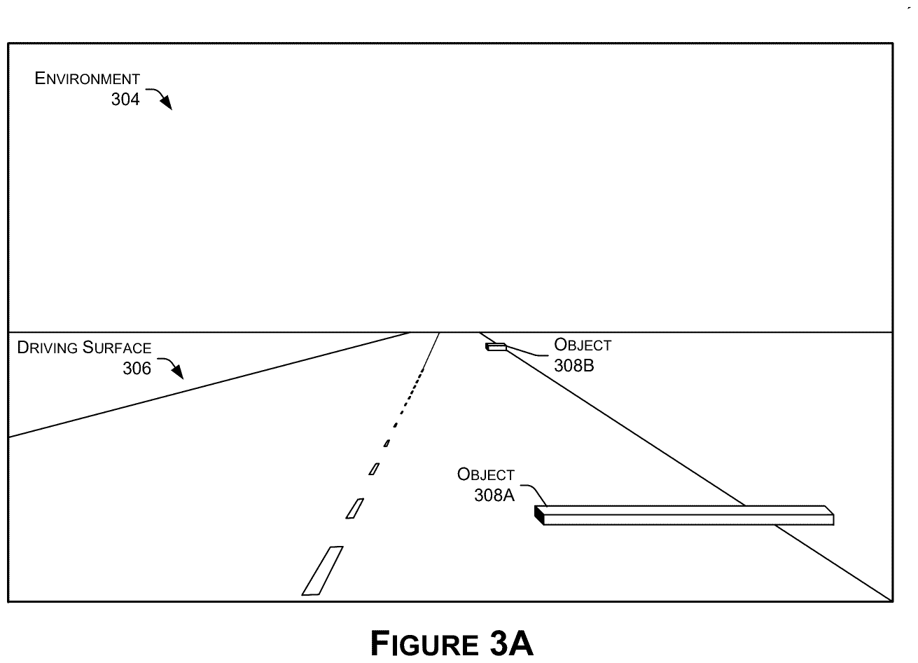

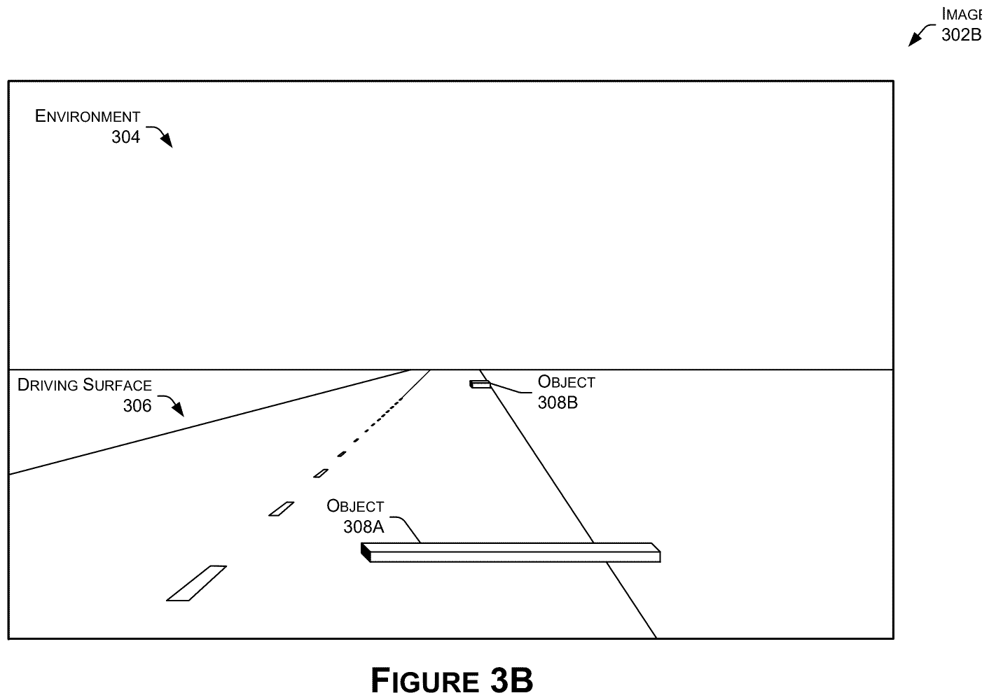

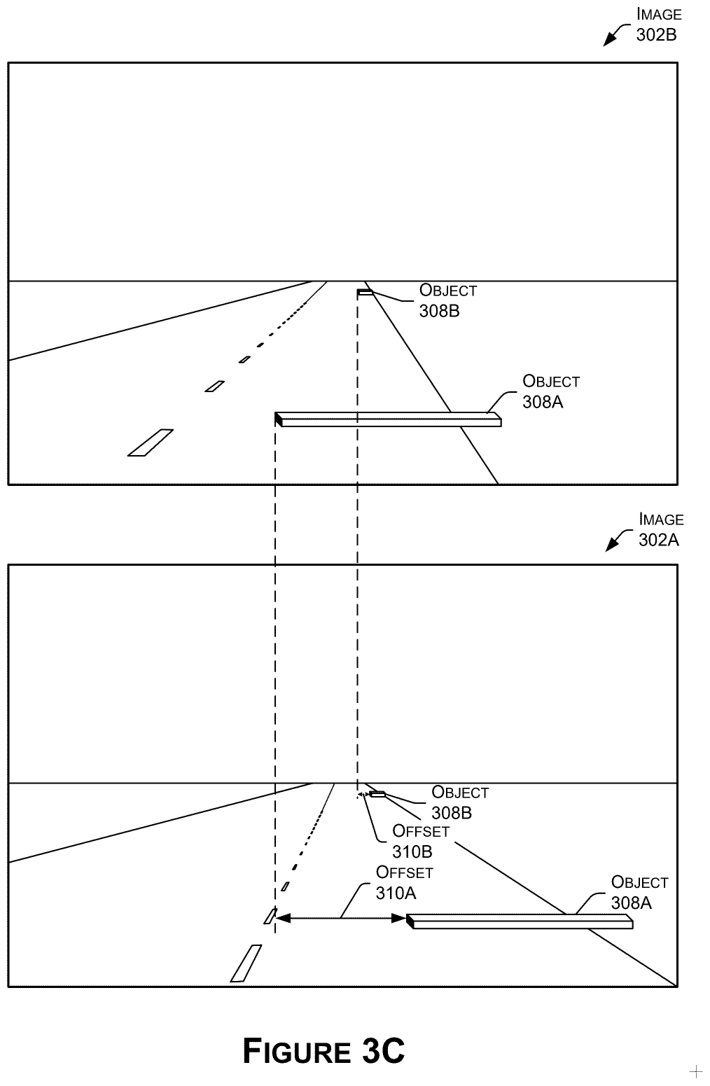

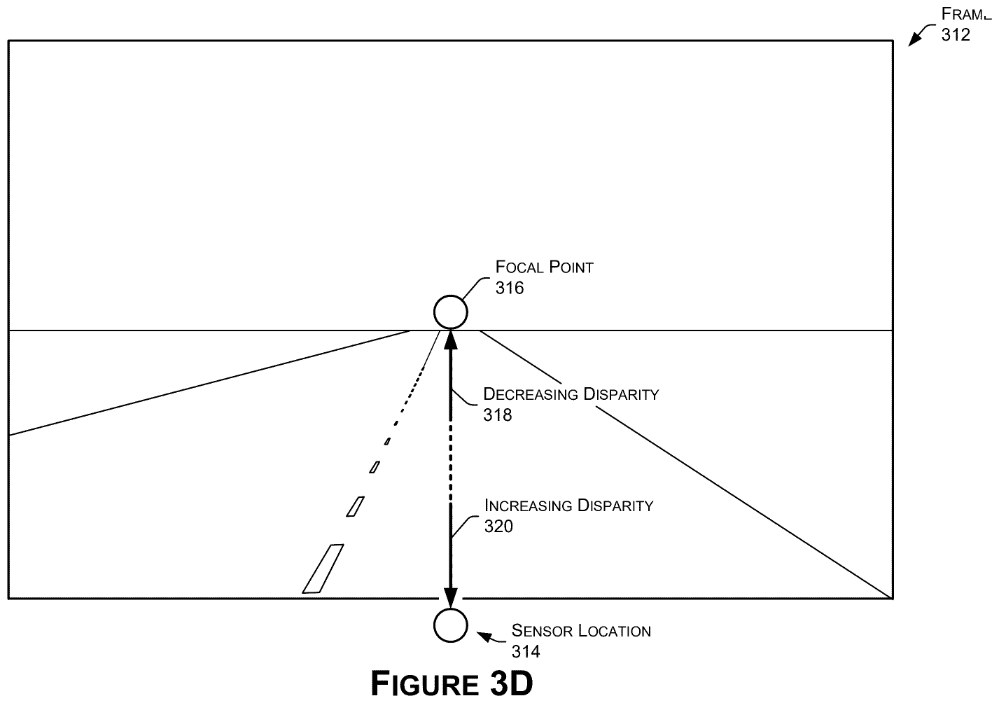

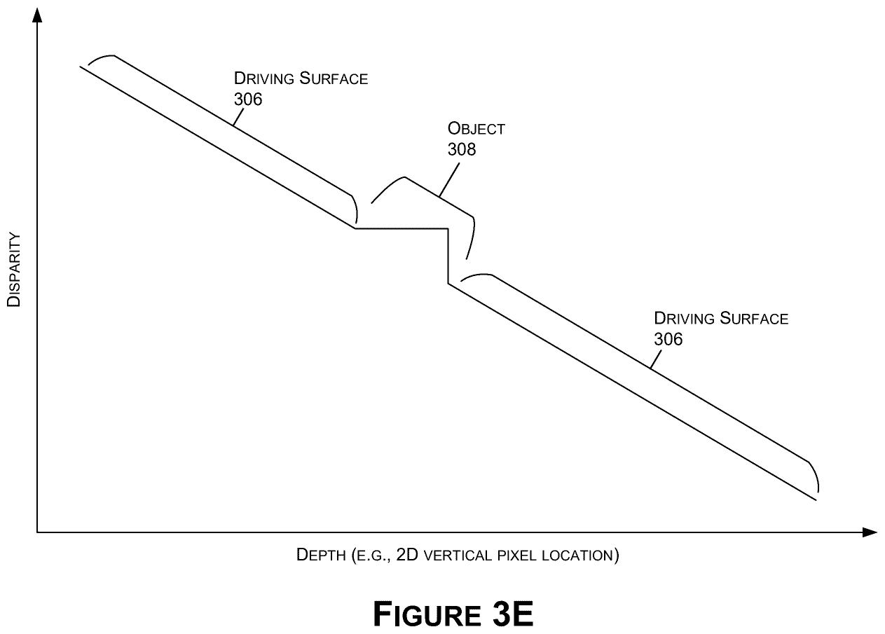

For instance, FIGS. 3A and 3B illustrate examples of images generated using different sensors of an approximate stereo pair, in accordance with some embodiments of the present disclosure. For instance, FIG. 3A illustrates an example of a first image 302A that may be captured using a first camera of a machine (e.g., a left-side camera) and FIG. 3B illustrates an example of a second image 302B that may be captured using a second camera of the machine (e.g., a right-side camera). The images 302 may depict an environment 304, which may include a driving surface 306 and one or more objects, such as a first object 308A and a second object 308B.

As described herein, one or more of the asynchronous sensors 102 may be positioned at different locations with respect to the machine and, as such, may capture different fields of view and/or sensory fields of the environment 304 (although the fields of view/sensory fields may at least partially overlap). Based at least on the asynchronous frames and/or the differing fields of view of the sensors 102, pixels in the images 302 that correspond to the same, physical locations in the environment 304 may “move” locations (e.g., within the image frames) between the first image 302A and the second image 302B.

For instance, FIG. 3C illustrates an example of displacements of the objects 308 between the different images 302 generated using the different sensors, in accordance with some embodiments of the present disclosure. As shown, when comparing the first image 302A and the second image 302B, a measurable amount of offset exists between the pixels/points corresponding to the objects 308 in the images 302. For instance, the first object 302A and the second object 302B appear to shift from left to right between the first image 302A and the second image 302B based on the field of view or perspective of the cameras used to generate the images 302. This shifting creates a first offset 310A associated with the first object 308A and a second offset 310B associated with the second object 308A. As shown, a magnitude of the first offset 310A is greater than the second offset 310B based on the distance of the first object 308A being closer to the machine/sensors than the second object 308B. This is because as distance or depth from the sensors increases, disparity between pixels in a pair of images may decrease.

For instance, FIG. 3D illustrates an example of a relationship between depth/distance and apparent disparity, in accordance with some embodiments of the present disclosure. In the example of FIG. 3D, an image frame 312 may be captured by a sensor (e.g., a camera) from a location of the sensor (e.g., sensor location 314). The image frame 312 may have an associated focal point 316 at or near the center of the frame 312. The focal point 316 may correspond to a location in the environment where the sensor is pointed or focused. While the image frame 312 is a two-dimensional (2D) image, in three-dimensional (3D) space locations near the focal point may generally be associated with decreasing disparity 318 while locations in the environment nearer to the sensor location 314 may be associated with increasing disparity 320. In other words, objects located closer to a pair of sensors separated by some distance may exhibit greater disparity between image pairs than objects located further away from the pair of sensors.

Referring back to the example of FIG. 1, the process 100 may include the object detection system(s) 104 using the association component 106 to perform one or more correspondence estimation steps to identify first points or pixels in the first sensor data 120A and second points or pixels in the second sensor data 120B that correspond to the same physical locations in the environment and/or the observed scene. For instance, the association component 106 may use optical flow estimation to determine first points or pixels in a first image frame of an approximate stereo pair and second points or pixels in a second image frame of the approximate stereo pair that correspond to the same locations, objects, or features in the environment or scene. In some examples, the association component 106 may store point/pixel mappings between sensor frame pairs. The mappings may indicate point/pixel locations between the frame pairs that map to one another.

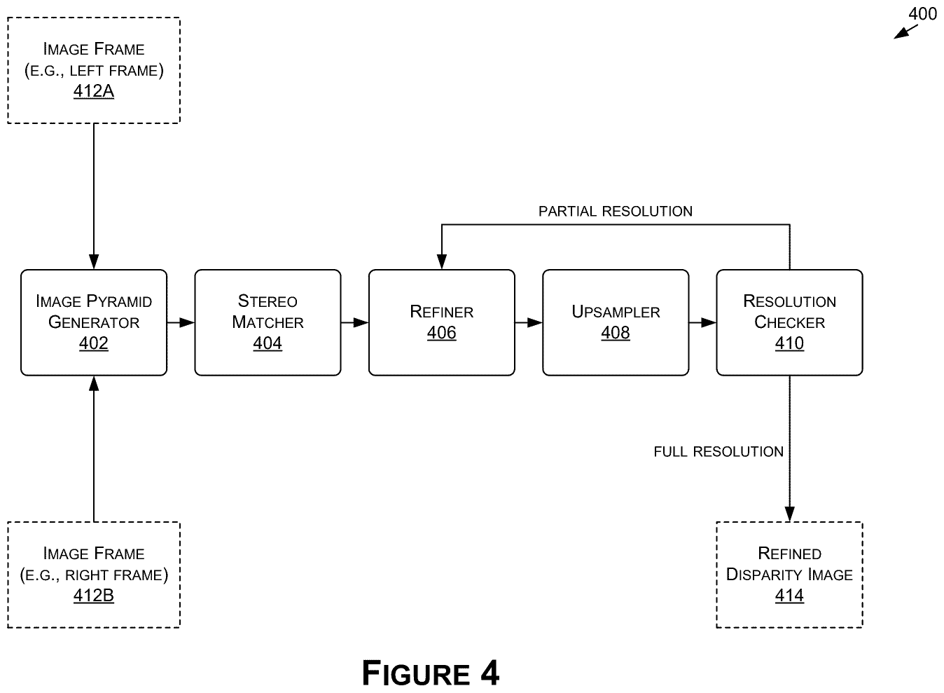

To overcome any limited convergence radius of the optical flow-based correspondence estimation, in some examples, the association component 106 may use a hierarchical search in an image pyramid. This hierarchical search in the image pyramid may allow the association component 106 to estimate dense flow fields for asynchronous image pairs that only approximately form a stereo pair. For instance, FIG. 4 is a data flow diagram illustrating an example of an optical flow process 400 for refining disparity images, in accordance with some embodiments of the present disclosure.

The process 400 may be implemented using, amongst additional or alternative components, an image pyramid generator 402, a stereo matcher 404, a refiner 406, an upsampler 408, and a resolution checker 410. In some examples, the association component 106 may include and implement one or more of the image pyramid generator 402, the stereo matcher 404, the refiner 406, the upsampler 408, and/or the resolution checker 410. Additionally, or alternatively, one or more other components or modules of the object detection system(s) 104 or components or modules not shown in FIG. 1 may be used to implement the process 400. For example, in some embodiments, an optical flow hardware accelerator (e.g., NVIDIA's optical flow accelerator (OFA)) may be used—e.g., as part of one or more systems-on-a-chip (SoCs) of the vehicle or machine, or as a discrete hardware component. The OFA may be capable of operating in a stereo disparity mode and/or an optical flow mode. In either case, the functionality/hardware capabilities of the OFA may be accessed using one or more application programming interfaces (APIs)—such as NVIDIA's image optical flow accelerator (IOFA) APIs.

In some examples, the process 400 may include the image pyramid generator generating one or more image pyramids using a first image frame 412A (e.g., a left image frame from the first sensor(s) 102A and/or a second image frame 412B (e.g., a right image frame from the second sensor(s) 102B). The image pyramid(s) may include multiple levels. For instance, a first level (e.g., level 0) may correspond to an original image frame, a second level (e.g., level 1) may correspond to an image that is one-half the resolution of the original image frame, a third level (e.g., level 2) may correspond to an image that is one-quarter the resolution of the original image frame, and so forth. The stereo matcher 404 may use the image pyramid(s) to perform stereo matching. For instance, the stereo matcher 404 may begin by using the coarsest pyramid layer (e.g., highest level) to perform stereo matching between the first image frame 412A and the second image frame 412B. The refiner 406 may use an optical flow algorithm(s) to refine a disparity image representing pixel disparities between the first image frame 412A and the second image frame 412B. The upsampler 408 may upsample one or more flow fields of the disparity image. The resolution checker 410 may determine whether the disparity image and/or the pyramid layer used for stereo matching was at its full resolution. If the resolution was at partial resolution, the process 400 may proceed back to the refiner 406, where the refiner 406 may up the level of the image pyramid and perform refinement using the higher resolution. Once the resolution checker 410 determines the full resolution was used/reached, a refined disparity image 414 may be output. The refined disparity image 414 may indicate the pixel displacements between the first image frame 412A and the second image frame 412B.

Referring back to the example of FIG. 1, the process 100 may include the object detection system(s) 104 using the disparity score component 108 to compute disparity scores (also referred to herein as “displacement scores) for one or more points (e.g., pixels or groups of pixels) of the asynchronous sensor data pair including the first sensor data 120A and the second sensor data 120B. The disparity scores may indicate magnitudes in movement of the points and/or pixels between the sensor data pair. For instance, and for an image pair that includes a first image from a first camera and a second image from a second camera, a disparity score may indicate an amount in which a pixel value corresponding to a specific point in the environment moved between a first pixel location in the first image to a second pixel location in the second image.

In some examples, the process 100 may include the evaluation component 110 evaluating the disparity scores with respect to the reference data 124 obtained using the reference component 116. For instance, the object detection system(s) 104 may assume that objects exhibit a measurable difference in disparity (e.g., x-parallax) when compared to disparity scores of a driving surface or other, relatively smooth surface in the environment surrounding the objects. As such, the evaluation component 110 may, in some instances, compute object detection scores for each point (e.g., pixel or group of pixels) of the sensor data pairs by comparing a point's or pixel's disparity value with those of adjacent points or pixels in rows (e.g., point or pixel rows in a frame) above and/or below. Because disparity generally decreases as range increases, if the decrease in disparity score is less than the disparity decrease observed in the rest of the environment surrounding an object, the evaluation component 110 may set the detection score to the difference in disparity. In some examples, the reference data 124 may indicate the typical disparity decrease in the environment, which may be defined either as an input parameter or automatically derived by the reference component 116 estimating the ground surface using the sensor data 120.

For instance, FIG. 3E illustrates an example visualization of using the relationship explained in the example of FIG. 3D to detect the presence of objects in an environment, in accordance with some embodiments of the present disclosure. That is, as range from a stereo pair or approximate stereo pair of sensors increases, apparent disparity decreases, and the evaluation component 110 may use these principles to detect objects in the environment. For instance, in FIG. 3E, an example graph is shown indicating these principles. If the evaluation component 110 was to plot depth versus disparity beginning from a location in the environment that is closest to the sensors (e.g., a bottom row of pixels of an image frame) and ending at a location in the environment that is furthest from the sensors (e.g., a row of pixels close to the camera focal point), the disparity between points corresponding to the driving surface 306 may be plotted as shown in the example of FIG. 3E. That is, the disparity between points of the driving surface 306 may decrease linearly, in some instances, as distance or depth increases (e.g., as pixel rows increase). At the location of the object 308, the disparity may be plotted as shown in the example of FIG. 3E. That is, the disparity between points corresponding to the object 308 may remain relatively constant for the object 308, as the depth of the object 308 may not change between pixel rows. However, once the pixels in a row of pixels no longer correspond to the object 308 and rather the driving surface 306, the disparity may continue to linearly decrease with depth.

Referring back to the example of FIG. 1, the process 100 may include, in some instances, the object detection system(s) 104 using the smoothing component 112 to smooth the disparity scores and/or detection scores by applying one or more filters. For instance, the smoothing component 112 may apply a Gaussian filter, a median filter, or any other type of filter to the disparity and/or displacement scores to reduce outliers or other inaccurate data and provide more reliable data. Additionally, in some examples, the object detection system(s) 104 may use the fusion component 114 to further enhance the accuracy and robustness for detecting objects (e.g., debris, traffic features or objects—such as cones or lane dividers, etc.) and/or features (e.g., potholes, cracks, protuberances—e.g., speed bumps, uprooted sections of road, etc.—from the road surface, etc.). The temporal fusion may, in some instances, leverage the derived optical flow to ascertain the position and corresponding detection score from preceding image pairs. The fusion component 114 may use incremental update schemas and trigger detections when the detection score surpasses a threshold.

In some examples, the object detection system(s) 104 may use a detection component 126 to detect the presence of objects in the environment based at least on the disparity scores and/or detection scores for image pixels corresponding to those objects meeting or exceeding a threshold, or decreasing less than surrounding image pixels corresponding to a driving surface. In some examples, the detection component 126 may estimate the locations of the objects based on the disparity scores and/or the locations of the pixels. For instance, image pixels that are closer to the bottom of an image frame and correspond to an object may be closer to the machine than image pixels that are closer to the middle and/or top of the image frame. Additionally, greater disparity scores may correspond to objects that are closer to the machine than smaller disparity scores, as disparity may decrease as range from the sensors/machine increases.

In some examples, the object detection system(s) 104 may output one or more of the object detection(s) 122 and the object detection may be used by the drive stack 118 of a machine to perform one or more operations associated with the machine. For instance, the drive stack 118 may cause the machine—such as the machine 200 or the machine 900—to perform one or more collision avoidance operations to avoid collisions with the objects. Such operations may include, but are not limited to, changing lanes, decreasing speed, coming to a stop, or performing machine to machine or machine to human communication operations (e.g., honking a horn, flashing lights, using turn signals, etc.).

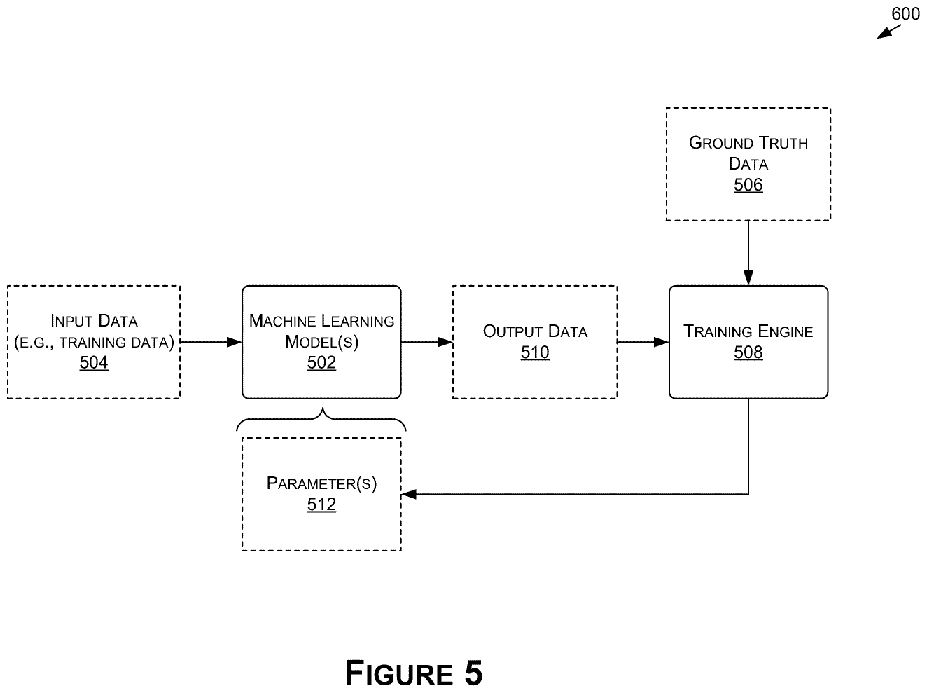

Referring now to FIG. 5, FIG. 5 is a data flow diagram illustrating an example of a process 500 for training one or more machine learning models 502 to detect objects using asynchronous, alternating images, in accordance with some embodiments of the present disclosure. For instance, the machine learning model(s) 502 may correspond to one or more of the components of the object detection system(s) 104, such as the association component 106, the disparity score component 108, the evaluation component 110, the smoothing component 112, the fusion component 114, the reference component 116, and/or the detection component 126.

As shown, the machine learning model(s) 502 may be trained using various input data 504 (e.g., training input data), which may include one or more of the sensor data 120 (e.g., approximate stereo image pairs), point or pixel disparity scores, point or pixel object detection scores, etc. In some examples, the input data 504 may include one or more actual (e.g., previously generated and/or stored) versions of the sensor data 120, the disparity scores, the detection scores, etc. Additionally, or alternatively, the input data 504 may be based on the actual versions of the sensor data 120, the disparity scores, and/or the detection scores. For instance, the input data 504 may include one or more modified versions of the image data 120, the disparity scores, and/or the detection scores.

The machine learning model(s) 502 may be trained using the input data 504 as well as corresponding ground truth data 506. The ground truth data 506 may include annotations, labels, masks, and/or the like. For example, in some embodiments, the ground truth data 506 may indicate actual values of parameters associated with an object(s) within the environment and/or the input data 504. For instance, and for the object(s), the parameters in the ground truth data 506 may include, but are not limited to, a x-coordinate location, a y-coordinate location, a z-coordinate location, a point location, a pixel location, a height, a width, a length, an orientation, a classification, point locations, bounding shape locations, bounding shape sizes, and/or any other parameter. The ground truth data 506 may be generated within a drawing program (e.g., an annotation program), a computer aided design (CAD) program, a labeling program, another type of program suitable for generating the ground truth data 506, and/or may be hand drawn, in some examples. In any example, the ground truth data 506 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer).

A training engine 508 may use one or more loss functions that measure loss (e.g., error) in output data 510 generated by the machine learning model(s) 502 as compared to the ground truth data 506. The output data 510 may include the disparity scores, the detection scores, object detections (e.g., bounding boxes, object locations, etc.), or any other outputs. In some examples, any type of loss function may be used, such as cross entropy loss, mean squared error, mean absolute error, mean bias error, and/or other loss function types. In some examples, different outputs may have different loss functions. For example, the x-coordinate location may include a first loss, the y-coordinate location may include a second loss, the z-coordinate location may include a third loss, and/or so forth. In such examples, the loss functions may be combined to form a total loss, and the total loss may be used by the training engine 508 to train the machine learning model(s) 502 by, in some instances, updating a parameter(s) 512 (e.g., weights, biases, etc.) of the machine learning model(s) 502. In any example, backward pass computations may be performed to recursively compute gradients of the loss function(s) with respect to training parameters. In some examples, weight and biases of the machine learning model(s) 502 may be used to compute these gradients.

For example, and without limitation, any of the various machine learning models described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, large language model, vision language model, multi-modal language model, transformer, diffusion, encoder only, decoder only, encoder-decoder, etc.), and/or other types of machine learning models and/or algorithms.

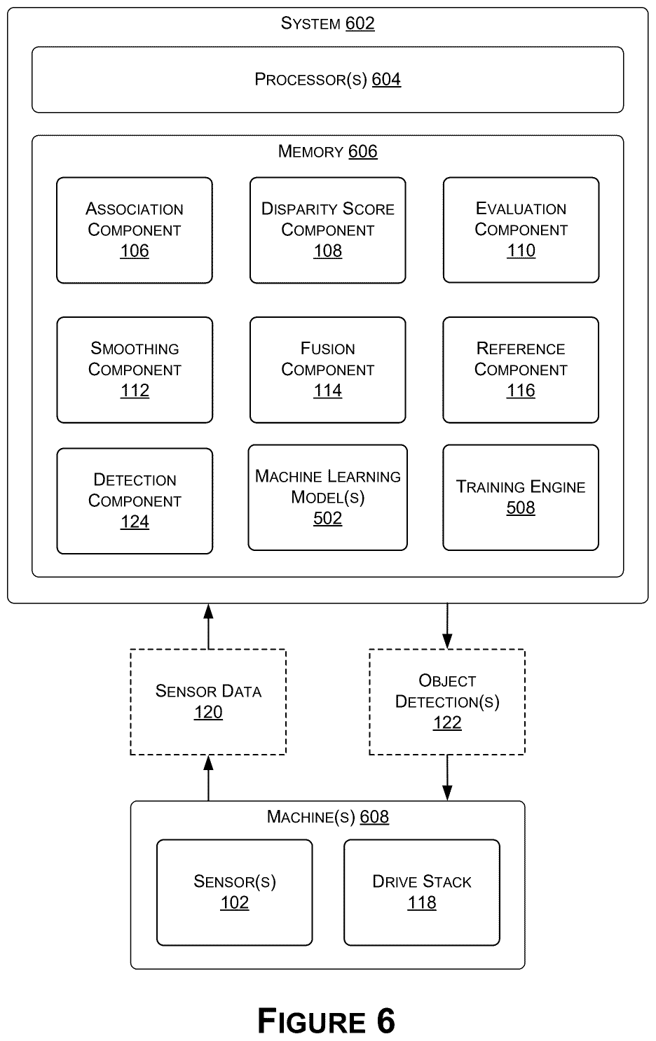

Referring now to FIG. 6, FIG. 6 illustrates an example of a system 602 that may perform one or more of the processes described herein, in accordance with some embodiments of the present disclosure. As shown, the system 602 (which may represent, and/or include, the example computing device(s) 1000 and/or the example data center 1100) may include one or more processors 604 (which may be similar to, and/or include, the CPUs 1006 and/or the GPUs 1008) and memory 606 (which may be similar to, and/or include, the memory 1004). For instance, the memory 606 may store one or more of the components of the object detection system(s) 104, such as the association component 106, the disparity score component 108, the evaluation component 110, the smoothing component 112, the fusion component 114, the reference component 116, the detection component 126, the machine learning model(s) 502, and the training engine 508. Additionally, the processor(s) 604 may execute the association component 106, the disparity score component 108, the evaluation component 110, the smoothing component 112, the fusion component 114, the reference component 116, the detection component 126, the machine learning model(s) 502, and/or the training engine 508 to perform one or more of the processes described herein. The system may further include an optical flow hardware accelerator, as described herein, to perform at least a portion of the processes described herein.

For instance, the system 602 may receive the sensor data 120 generated by the sensor(s) 102 of one or more machines 608, which may correspond to the machine 202 or the machine 900. The sensor data 120 may include an approximate stereo pair of images or other sensor data frames. The system 602 may then process and evaluate the sensor data 120 in order to detect objects in an environment surrounding the machine(s) 608. The system 602 may send data indicating object detection(s) 122 to the machine(s) 608. The drive stack 118 of the machine(s) 608 may use the object detection(s) 122 to influence and determine one or more control operations of the machine(s) 608.

Although depicted as being separate systems, the system 602 and the machine(s) 608 may, in some examples, be the same or different systems. For instance, the processor(s) 604 and the memory 606 may be part of the machine(s) 608 (e.g., included within a computing device of the machine(s) 608).

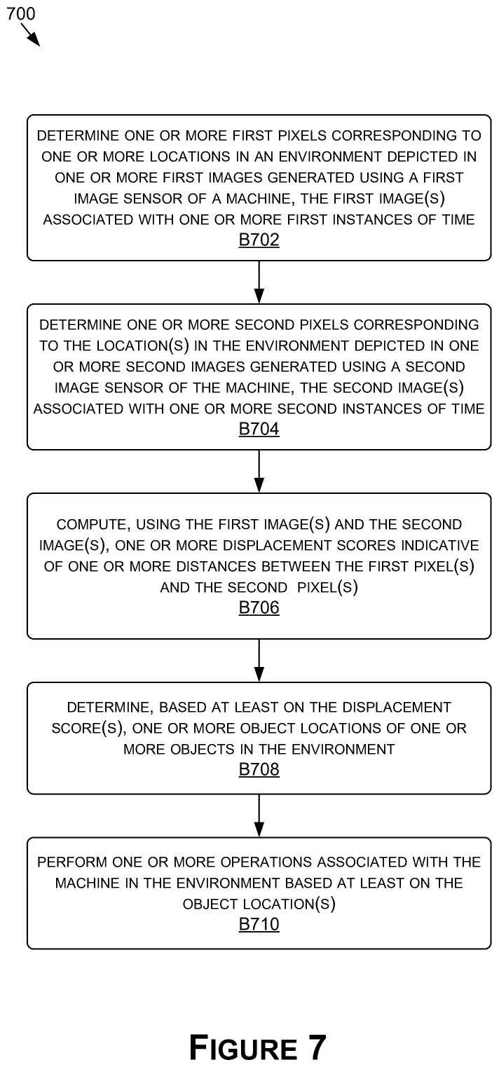

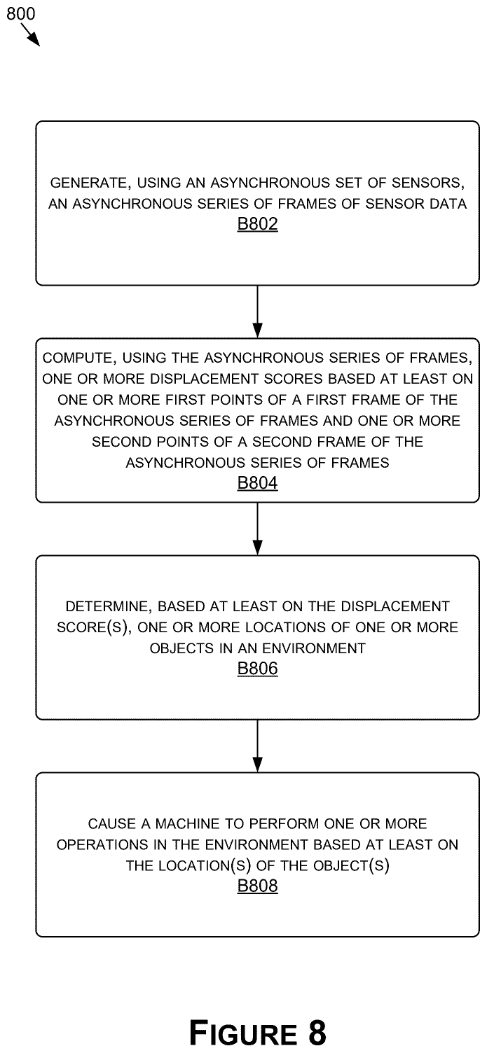

Now referring to FIGS. 7 and 8, each block of methods 700 and 800, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 700 and 800 are described, by way of example, with respect to FIG. 1. However, these methods may additionally or alternatively be executed by any one system, or any combination of systems, including, but not limited to, those described herein.

FIG. 7 is a flow diagram illustrating an example of a method 700 for controlling operations of a vehicle based at least on detecting objects in an environment using asynchronous images, in accordance with some embodiments of the present disclosure. The method 700, at block B702, may include determining one or more first pixels corresponding to one or more locations in an environment depicted in one or more first images generated using a first image sensor of a machine, the first image(s) associated with one or more first instances of time. For instance, the association component 106 may determine the first pixel(s) corresponding to the location(s) in the environment depicted in the first image(s) generated using the first image sensor of the machine.

The method 700, at block B704, may include determining one or more second pixels corresponding to the location(s) in the environment depicted in one or more second images generated using a second image sensor of the machine, the second image(s) associated with one or more second instances of time. For instance, the association component 106 may determine the second pixel(s) corresponding to the location(s) in the environment depicted in the second image(s) generated using the second image sensor of the machine. In some examples, the first image(s) may be associated with the first instance(s) of time and the second image(s) may be associated with the second instance(s) of time. That is, the first image(s) may be captured at the first instance(s) of time and the second image(s) may be captured at the second instance(s) of time.

The method 700, at block B706, may include computing, using the first image(s) and the second image(s), one or more displacement scores indicative of one or more distances between the first pixel(s) and the second pixel(s). For instance, the disparity score component 108 may compute the displacement score(s) (also referred to herein as “disparity scores”). The displacement score(s) may indicate the distance(s) between the first pixel(s) and the second pixel(s). That is, in the first image(s) a first pixel or group of first pixels corresponding to a specific object in an environment may be positioned, within the image frame, at one or more first location(s). However, in the second image(s) a second pixel or group of second pixels corresponding to the specific object may be positioned, within the image frame, at one or more second location(s). the disparity score component 108 may determine a magnitude of the displacement or movement of these pixels between the first image(s) and the second image(s).

The method 700, at block B708, may include determining, based at least on the displacement score(s), one or more object locations of one or more objects in the environment. For instance, the detection component 126 of the object detection system(s) 104 may determine the object location(s) of the object(s) in the environment. In some examples, the object location(s) may include a horizontal distance between the first image sensor and/or the second image sensor and the object(s). Additionally, the object location(s) may indicate a lateral distance between a path of the machine and the object(s). In some instances, the detection component 126 may detect other attributes of the object(s), such as a size(s) (e.g., a length(s), a height(s), etc.) of the object(s), classifications of the object(s), whether the object(s) are static or dynamic, etc.

The method 700, at block B710, may include performing one or more operations associated with the machine in the environment based at least on the object location(s). For instance, the drive stack 118 may use the object detection(s) 122 to perform the operation(s) associated with the machine in the environment. In some examples, the operation(s) may include a collision avoidance operation(s) or any other operations to steer the machine around the object(s). For instance, the operation(s) may include, but is not limited to, changing lanes, decelerating, altering a path (e.g., detour), stopping the machine, yielding, communicative operations (e.g., honking, flashing lights, etc.), invoking a remote operator, etc.

Referring now to FIG. 8, FIG. 8 is a flow diagram illustrating an example of a method 800 for determining object locations in an environment using an asynchronous series of frames of sensor data, in accordance with some embodiments of the present disclosure. The method 800, at block B802, may include generating, using an asynchronous set of sensors, an asynchronous series of frames of sensor data. For instance, the sensors 102 may generate the sensor data 120. The sensor data 120 may represent one or more frames of sensor data of the asynchronous series of frames.

The method 800, at block B804, may include computing, using the asynchronous series of frames, one or more displacement scores based at least on one or more first points of a first frame of the asynchronous series of frames and one or more second points of a second frame of the asynchronous series of frames. For instance, the disparity score component 108 may compute the displacement score(s). The displacement score(s) may indicate the distance(s) between the first point(s) and the second point(s). That is, in the first frame a first point or group of first points corresponding to a specific object in an environment may be positioned, within the first frame, at one or more first location(s). However, in the second frame a second point or group of second points corresponding to the specific object may be positioned, within the second frame, at one or more second location(s). The disparity score component 108 may determine a magnitude of the displacement or movement of these point between the first frame and the second frame.

The method 800, at block B806, may include determining, based at least on the displacement score(s), one or more locations of one or more objects in an environment. For instance, the detection component 126 may determine the location(s) of the object(s) in the environment. In some examples, the location(s) may include a horizontal distance between the asynchronous pair of sensors and the object(s). Additionally, the object location(s) may indicate a lateral distance between a path of a machine (e.g., a machine associated with or including the asynchronous sensors) and the object(s). In some instances, the detection component 126 may detect other attributes of the object(s), such as a size(s) (e.g., a length(s), a height(s), etc.) of the object(s), classifications of the object(s), whether the object(s) are static or dynamic, etc.

The method 800, at block B808, may include causing a machine to perform one or more operations in the environment based at least on the location(s) of the object(s). For instance, the drive stack 118 may use the object detection(s) 122 to cause the machine to perform the operation(s) in the environment. In some examples, the operation(s) may include a collision avoidance operation(s) or any other operations to steer the machine around the object(s). For instance, the operation(s) may include, but is not limited to, changing lanes, decelerating, altering a path (e.g., detour), stopping the machine, yielding, communicative operations (e.g., honking, flashing lights, etc.), invoking a remote operator, etc.

### EXAMPLE AUTONOMOUS VEHICLE

FIG. 9A is an illustration of an example autonomous vehicle 900, in accordance with some embodiments of the present disclosure. The autonomous vehicle 900 (alternatively referred to herein as the “vehicle 900”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 900 may be capable of functionality in accordance with one or more of Level 3-Level 5 of the autonomous driving levels. The vehicle 900 may be capable of functionality in accordance with one or more of Level 1-Level 5 of the autonomous driving levels. For example, the vehicle 900 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 900 or other machine, such as being fully autonomous, being highly autonomous, being conditionally autonomous, being partially autonomous, providing assistive autonomy, being semi-autonomous, being primarily autonomous, or other designation.

The vehicle 900 may include components such as a chassis, a vehicle body, wheels (e.g., 2, 4, 6, 8, 18, etc.), tires, axles, and other components of a vehicle. The vehicle 900 may include a propulsion system 950, such as an internal combustion engine, hybrid electric power plant, an all-electric engine, and/or another propulsion system type. The propulsion system 950 may be connected to a drive train of the vehicle 900, which may include a transmission, to enable the propulsion of the vehicle 900. The propulsion system 950 may be controlled in response to receiving signals from the throttle/accelerator 952.

A steering system 954, which may include a steering wheel, may be used to steer the vehicle 900 (e.g., along a desired path or route) when the propulsion system 950 is operating (e.g., when the vehicle is in motion). The steering system 954 may receive signals from a steering actuator 956. The steering wheel may be optional for full automation (Level 5) functionality.

The brake sensor system 946 may be used to operate the vehicle brakes in response to receiving signals from the brake actuators 948 and/or brake sensors.

Controller(s) 936, which may include one or more system on chips (SoCs) 904 (FIG. 9C) and/or GPU(s), may provide signals (e.g., representative of commands) to one or more components and/or systems of the vehicle 900. For example, the controller(s) may send signals to operate the vehicle brakes via one or more brake actuators 948, to operate the steering system 954 via one or more steering actuators 956, to operate the propulsion system 950 via one or more throttle/accelerators 952. The controller(s) 936 may include one or more onboard (e.g., integrated) computing devices (e.g., supercomputers) that process sensor signals, and output operation commands (e.g., signals representing commands) to enable autonomous driving and/or to assist a human driver in driving the vehicle 900. The controller(s) 936 may include a first controller 936 for autonomous driving functions, a second controller 936 for functional safety functions, a third controller 936 for artificial intelligence functionality (e.g., computer vision), a fourth controller 936 for infotainment functionality, a fifth controller 936 for redundancy in emergency conditions, and/or other controllers. In some examples, a single controller 936 may handle two or more of the above functionalities, two or more controllers 936 may handle a single functionality, and/or any combination thereof.

The controller(s) 936 may provide the signals for controlling one or more components and/or systems of the vehicle 900 in response to sensor data received from one or more sensors (e.g., sensor inputs). The sensor data may be received from, for example and without limitation, global navigation satellite systems (“GNSS”) sensor(s) 958 (e.g., Global Positioning System sensor(s)), RADAR sensor(s) 960, ultrasonic sensor(s) 962, LIDAR sensor(s) 964, inertial measurement unit (IMU) sensor(s) 966 (e.g., accelerometer(s), gyroscope(s), magnetic compass(es), magnetometer(s), etc.), microphone(s) 996, stereo camera(s) 968, wide-view camera(s) 970 (e.g., fisheye cameras), infrared camera(s) 972, surround camera(s) 974 (e.g., 360 degree cameras), long-range and/or mid-range camera(s) 998, speed sensor(s) 944 (e.g., for measuring the speed of the vehicle 900), vibration sensor(s) 942, steering sensor(s) 940, brake sensor(s) (e.g., as part of the brake sensor system 946), and/or other sensor types.

One or more of the controller(s) 936 may receive inputs (e.g., represented by input data) from an instrument cluster 932 of the vehicle 900 and provide outputs (e.g., represented by output data, display data, etc.) via a human-machine interface (HMI) display 934, an audible annunciator, a loudspeaker, and/or via other components of the vehicle 900. The outputs may include information such as vehicle velocity, speed, time, map data (e.g., the High Definition (“HD”) map 922 of FIG. 9C), location data (e.g., the vehicle's 900 location, such as on a map), direction, location of other vehicles (e.g., an occupancy grid), information about objects and status of objects as perceived by the controller(s) 936, etc. For example, the HMI display 934 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 900 further includes a network interface 924 which may use one or more wireless antenna(s) 926 and/or modem(s) to communicate over one or more networks. For example, the network interface 924 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 926 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 9B is an example of camera locations and fields of view for the example autonomous vehicle 900 of FIG. 9A, in accordance with some embodiments of the present disclosure. The cameras and respective fields of view are one example embodiment and are not intended to be limiting. For example, additional and/or alternative cameras may be included and/or the cameras may be located at different locations on the vehicle 900.

The camera types for the cameras may include, but are not limited to, digital cameras that may be adapted for use with the components and/or systems of the vehicle 900. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 900 (e.g., front-facing cameras) may be used for surround view, to help identify forward facing paths and obstacles, as well aid in, with the help of one or more controllers 936 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 970 that may be used to perceive objects coming into view from the periphery (e.g., pedestrians, crossing traffic or bicycles). Although only one wide-view camera is illustrated in FIG. 9B, there may be any number (including zero) of wide-view cameras 970 on the vehicle 900. In addition, any number of long-range camera(s) 998 (e.g., a long-view stereo camera pair) may be used for depth-based object detection, especially for objects for which a neural network has not yet been trained. The long-range camera(s) 998 may also be used for object detection and classification, as well as basic object tracking.

Any number of stereo cameras 968 may also be included in a front-facing configuration. In at least one embodiment, one or more of stereo camera(s) 968 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 968 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 968 may be used in addition to, or alternatively from, those described herein.

Cameras with a field of view that include portions of the environment to the side of the vehicle 900 (e.g., side-view cameras) may be used for surround view, providing information used to create and update the occupancy grid, as well as to generate side impact collision warnings. For example, surround camera(s) 974 (e.g., four surround cameras 974 as illustrated in FIG. 9B) may be positioned to on the vehicle 900. The surround camera(s) 974 may include wide-view camera(s) 970, fisheye camera(s), 360 degree camera(s), and/or the like. Four example, four fisheye cameras may be positioned on the vehicle's front, rear, and sides. In an alternative arrangement, the vehicle may use three surround camera(s) 974 (e.g., left, right, and rear), and may leverage one or more other camera(s) (e.g., a forward-facing camera) as a fourth surround view camera.

Cameras with a field of view that include portions of the environment to the rear of the vehicle 900 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 998, stereo camera(s) 968), infrared camera(s) 972, etc.), as described herein.

FIG. 9C is a block diagram of an example system architecture for the example autonomous vehicle 900 of FIG. 9A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 900 in FIG. 9C are illustrated as being connected via bus 902. The bus 902 may include a Controller Area Network (CAN) data interface (alternatively referred to herein as a “CAN bus”). A CAN may be a network inside the vehicle 900 used to aid in control of various features and functionality of the vehicle 900, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 902 is described herein as being a CAN bus, this is not intended to be limiting. For example, in addition to, or alternatively from, the CAN bus, FlexRay and/or Ethernet may be used. Additionally, although a single line is used to represent the bus 902, this is not intended to be limiting. For example, there may be any number of busses 902, which may include one or more CAN busses, one or more FlexRay busses, one or more Ethernet busses, and/or one or more other types of busses using a different protocol. In some examples, two or more busses 902 may be used to perform different functions, and/or may be used for redundancy. For example, a first bus 902 may be used for collision avoidance functionality and a second bus 902 may be used for actuation control. In any example, each bus 902 may communicate with any of the components of the vehicle 900, and two or more busses 902 may communicate with the same components. In some examples, each SoC 904, each controller 936, and/or each computer within the vehicle may have access to the same input data (e.g., inputs from sensors of the vehicle 900), and may be connected to a common bus, such the CAN bus.

The vehicle 900 may include one or more controller(s) 936, such as those described herein with respect to FIG. 9A. The controller(s) 936 may be used for a variety of functions. The controller(s) 936 may be coupled to any of the various other components and systems of the vehicle 900, and may be used for control of the vehicle 900, artificial intelligence of the vehicle 900, infotainment for the vehicle 900, and/or the like.

The vehicle 900 may include a system(s) on a chip (SoC) 904. The SoC 904 may include CPU(s) 906, GPU(s) 908, processor(s) 910, cache(s) 912, accelerator(s) 914, data store(s) 916, and/or other components and features not illustrated. The SoC(s) 904 may be used to control the vehicle 900 in a variety of platforms and systems. For example, the SoC(s) 904 may be combined in a system (e.g., the system of the vehicle 900) with an HD map 922 which may obtain map refreshes and/or updates via a network interface 924 from one or more servers (e.g., server(s) 978 of FIG. 9D).

The CPU(s) 906 may include a CPU cluster or CPU complex (alternatively referred to herein as a “CCPLEX”). The CPU(s) 906 may include multiple cores and/or L2 caches. For example, in some embodiments, the CPU(s) 906 may include eight cores in a coherent multi-processor configuration. In some embodiments, the CPU(s) 906 may include four dual-core clusters where each cluster has a dedicated L2 cache (e.g., a 2 MB L2 cache). The CPU(s) 906 (e.g., the CCPLEX) may be configured to support simultaneous cluster operation enabling any combination of the clusters of the CPU(s) 906 to be active at any given time.

The CPU(s) 906 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 906 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 908 may include an integrated GPU (alternatively referred to herein as an “iGPU”). The GPU(s) 908 may be programmable and may be efficient for parallel workloads. The GPU(s) 908, in some examples, may use an enhanced tensor instruction set. The GPU(s) 908 may include one or more streaming microprocessors, where each streaming microprocessor may include an L1 cache (e.g., an L1 cache with at least 96KB storage capacity), and two or more of the streaming microprocessors may share an L2 cache (e.g., an L2 cache with a 512 KB storage capacity). In some embodiments, the GPU(s) 908 may include at least eight streaming microprocessors. The GPU(s) 908 may use compute application programming interface(s) (API(s)). In addition, the GPU(s) 908 may use one or more parallel computing platforms and/or programming models (e.g., NVIDIA's CUDA).

The GPU(s) 908 may be power-optimized for best performance in automotive and embedded use cases. For example, the GPU(s) 908 may be fabricated on a Fin field-effect transistor (FinFET). However, this is not intended to be limiting and the GPU(s) 908 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 908 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 908 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 908 to access the CPU(s) 906 page tables directly. In such examples, when the GPU(s) 908 memory management unit (MMU) experiences a miss, an address translation request may be transmitted to the CPU(s) 906. In response, the CPU(s) 906 may look in its page tables for the virtual-to-physical mapping for the address and transmits the translation back to the GPU(s) 908. As such, unified memory technology may allow a single unified virtual address space for memory of both the CPU(s) 906 and the GPU(s) 908, thereby simplifying the GPU(s) 908 programming and porting of applications to the GPU(s) 908.

In addition, the GPU(s) 908 may include an access counter that may keep track of the frequency of access of the GPU(s) 908 to memory of other processors. The access counter may help ensure that memory pages are moved to the physical memory of the processor that is accessing the pages most frequently.

The SoC(s) 904 may include any number of cache(s) 912, including those described herein. For example, the cache(s) 912 may include an L3 cache that is available to both the CPU(s) 906 and the GPU(s) 908 (e.g., that is connected both the CPU(s) 906 and the GPU(s) 908). The cache(s) 912 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 904 may include an arithmetic logic unit(s) (ALU(s)) which may be leveraged in performing processing with respect to any of the variety of tasks or operations of the vehicle 900—such as processing DNNs. In addition, the SoC(s) 904 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 906 and/or GPU(s) 908.

The SoC(s) 904 may include one or more accelerators 914 (e.g., hardware accelerators, software accelerators, or a combination thereof). For example, the SoC(s) 904 may include a hardware acceleration cluster that may include optimized hardware accelerators and/or large on-chip memory. The large on-chip memory (e.g., 4MB of SRAM), may enable the hardware acceleration cluster to accelerate neural networks and other calculations. The hardware acceleration cluster may be used to complement the GPU(s) 908 and to off-load some of the tasks of the GPU(s) 908 (e.g., to free up more cycles of the GPU(s) 908 for performing other tasks). As an example, the accelerator(s) 914 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 914 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 908, and by using an inference accelerator, for example, a designer may target either the DLA(s) or the GPU(s) 908 for any function. For example, the designer may focus processing of CNNs and floating point operations on the DLA(s) and leave other functions to the GPU(s) 908 and/or other accelerator(s) 914.

The accelerator(s) 914 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 906. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 914 (e.g., the hardware acceleration cluster) may include a computer vision network on-chip and SRAM, for providing a high-bandwidth, low latency SRAM for the accelerator(s) 914. In some examples, the on-chip memory may include at least 4MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 904 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 914 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 966 output that correlates with the vehicle 900 orientation, distance, 3D location estimates of the object obtained from the neural network and/or other sensors (e.g., LIDAR sensor(s) 964 or RADAR sensor(s) 960), among others.

The SoC(s) 904 may include data store(s) 916 (e.g., memory). The data store(s) 916 may be on-chip memory of the SoC(s) 904, which may store neural networks to be executed on the GPU and/or the DLA. In some examples, the data store(s) 916 may be large enough in capacity to store multiple instances of neural networks for redundancy and safety. The data store(s) 912 may comprise L2 or L3 cache(s) 912. Reference to the data store(s) 916 may include reference to the memory associated with the PVA, DLA, and/or other accelerator(s) 914, as described herein.

The SoC(s) 904 may include one or more processor(s) 910 (e.g., embedded processors). The processor(s) 910 may include a boot and power management processor that may be a dedicated processor and subsystem to handle boot power and management functions and related security enforcement. The boot and power management processor may be a part of the SoC(s) 904 boot sequence and may provide runtime power management services. The boot power and management processor may provide clock and voltage programming, assistance in system low power state transitions, management of SoC(s) 904 thermals and temperature sensors, and/or management of the SoC(s) 904 power states. Each temperature sensor may be implemented as a ring-oscillator whose output frequency is proportional to temperature, and the SoC(s) 904 may use the ring-oscillators to detect temperatures of the CPU(s) 906, GPU(s) 908, and/or accelerator(s) 914. If temperatures are determined to exceed a threshold, the boot and power management processor may enter a temperature fault routine and put the SoC(s) 904 into a lower power state and/or put the vehicle 900 into a chauffeur to safe stop mode (e.g., bring the vehicle 900 to a safe stop).

The processor(s) 910 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 910 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 910 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 910 may further include a real-time camera engine that may include a dedicated processor subsystem for handling real-time camera management.

The processor(s) 910 may further include a high-dynamic range signal processor that may include an image signal processor that is a hardware engine that is part of the camera processing pipeline.

The processor(s) 910 may include a video image compositor that may be a processing block (e.g., implemented on a microprocessor) that implements video post-processing functions needed by a video playback application to produce the final image for the player window. The video image compositor may perform lens distortion correction on wide-view camera(s) 970, surround camera(s) 974, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 908 is not required to continuously render new surfaces. Even when the GPU(s) 908 is powered on and active doing 3D rendering, the video image compositor may be used to offload the GPU(s) 908 to improve performance and responsiveness.

The SoC(s) 904 may further include a mobile industry processor interface (MIPI) camera serial interface for receiving video and input from cameras, a high-speed interface, and/or a video input block that may be used for camera and related pixel input functions. The SoC(s) 904 may further include an input/output controller(s) that may be controlled by software and may be used for receiving I/O signals that are uncommitted to a specific role.

The SoC(s) 904 may further include a broad range of peripheral interfaces to enable communication with peripherals, audio codecs, power management, and/or other devices. The SoC(s) 904 may be used to process data from cameras (e.g., connected over Gigabit Multimedia Serial Link and Ethernet), sensors (e.g., LIDAR sensor(s) 964, RADAR sensor(s) 960, etc. that may be connected over Ethernet), data from bus 902 (e.g., speed of vehicle 900, steering wheel position, etc.), data from GNSS sensor(s) 958 (e.g., connected over Ethernet or CAN bus). The SoC(s) 904 may further include dedicated high-performance mass storage controllers that may include their own DMA engines, and that may be used to free the CPU(s) 906 from routine data management tasks.

The SoC(s) 904 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 904 may be faster, more reliable, and even more energy-efficient and space-efficient than conventional systems. For example, the accelerator(s) 914, when combined with the CPU(s) 906, the GPU(s) 908, and the data store(s) 916, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 920) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 908.

In some examples, a CNN for facial recognition and vehicle owner identification may use data from camera sensors to identify the presence of an authorized driver and/or owner of the vehicle 900. The always on sensor processing engine may be used to unlock the vehicle when the owner approaches the driver door and turn on the lights, and, in security mode, to disable the vehicle when the owner leaves the vehicle. In this way, the SoC(s) 904 provide for security against theft and/or carjacking.

In another example, a CNN for emergency vehicle detection and identification may use data from microphones 996 to detect and identify emergency vehicle sirens. In contrast to conventional systems, that use general classifiers to detect sirens and manually extract features, the SoC(s) 904 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 958. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 962, until the emergency vehicle(s) passes.

The vehicle may include a CPU(s) 918 (e.g., discrete CPU(s), or dCPU(s)), that may be coupled to the SoC(s) 904 via a high-speed interconnect (e.g., PCIe). The CPU(s) 918 may include an X86 processor, for example. The CPU(s) 918 may be used to perform any of a variety of functions, including arbitrating potentially inconsistent results between ADAS sensors and the SoC(s) 904, and/or monitoring the status and health of the controller(s) 936 and/or infotainment SoC 930, for example.

The vehicle 900 may include a GPU(s) 920 (e.g., discrete GPU(s), or dGPU(s)), that may be coupled to the SoC(s) 904 via a high-speed interconnect (e.g., NVIDIA's NVLINK). The GPU(s) 920 may provide additional artificial intelligence functionality, such as by executing redundant and/or different neural networks, and may be used to train and/or update neural networks based on input (e.g., sensor data) from sensors of the vehicle 900.

The vehicle 900 may further include the network interface 924 which may include one or more wireless antennas 926 (e.g., one or more wireless antennas for different communication protocols, such as a cellular antenna, a Bluetooth antenna, etc.). The network interface 924 may be used to enable wireless connectivity over the Internet with the cloud (e.g., with the server(s) 978 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 900 information about vehicles in proximity to the vehicle 900 (e.g., vehicles in front of, on the side of, and/or behind the vehicle 900). This functionality may be part of a cooperative adaptive cruise control functionality of the vehicle 900.

The network interface 924 may include a SoC that provides modulation and demodulation functionality and enables the controller(s) 936 to communicate over wireless networks. The network interface 924 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 900 may further include data store(s) 928 which may include off-chip (e.g., off the SoC(s) 904) storage. The data store(s) 928 may include one or more storage elements including RAM, SRAM, DRAM, VRAM, Flash, hard disks, and/or other components and/or devices that may store at least one bit of data.

The vehicle 900 may further include GNSS sensor(s) 958. The GNSS sensor(s) 958 (e.g., GPS, assisted GPS sensors, differential GPS (DGPS) sensors, etc.), to assist in mapping, perception, occupancy grid generation, and/or path planning functions. Any number of GNSS sensor(s) 958 may be used, including, for example and without limitation, a GPS using a USB connector with an Ethernet to Serial (RS-232) bridge.

The vehicle 900 may further include RADAR sensor(s) 960. The RADAR sensor(s) 960 may be used by the vehicle 900 for long-range vehicle detection, even in darkness and/or severe weather conditions. RADAR functional safety levels may be ASIL B. The RADAR sensor(s) 960 may use the CAN and/or the bus 902 (e.g., to transmit data generated by the RADAR sensor(s) 960) for control and to access object tracking data, with access to Ethernet to access raw data in some examples. A wide variety of RADAR sensor types may be used. For example, and without limitation, the RADAR sensor(s) 960 may be suitable for front, rear, and side RADAR use. In some example, Pulse Doppler RADAR sensor(s) are used.

The RADAR sensor(s) 960 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 960 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 900 surroundings at higher speeds with minimal interference from traffic in adjacent lanes. The other two antennae may expand the field of view, making it possible to quickly detect vehicles entering or leaving the vehicle's 900 lane.

Mid-range RADAR systems may include, as an example, a range of up to 960 m (front) or 80 m (rear), and a field of view of up to 42 degrees (front) or 950 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 900 may further include ultrasonic sensor(s) 962. The ultrasonic sensor(s) 962, which may be positioned at the front, back, and/or the sides of the vehicle 900, may be used for park assist and/or to create and update an occupancy grid. A wide variety of ultrasonic sensor(s) 962 may be used, and different ultrasonic sensor(s) 962 may be used for different ranges of detection (e.g., 2.5 m, 4 m). The ultrasonic sensor(s) 962 may operate at functional safety levels of ASIL B.

The vehicle 900 may include LIDAR sensor(s) 964. The LIDAR sensor(s) 964 may be used for object and pedestrian detection, emergency braking, collision avoidance, and/or other functions. The LIDAR sensor(s) 964 may be functional safety level ASIL B. In some examples, the vehicle 900 may include multiple LIDAR sensors 964 (e.g., two, four, six, etc.) that may use Ethernet (e.g., to provide data to a Gigabit Ethernet switch).

In some examples, the LIDAR sensor(s) 964 may be capable of providing a list of objects and their distances for a 360-degree field of view. Commercially available LIDAR sensor(s) 964 may have an advertised range of approximately 900 m, with an accuracy of 2 cm-3 cm, and with support for a 900 Mbps Ethernet connection, for example. In some examples, one or more non-protruding LIDAR sensors 964 may be used. In such examples, the LIDAR sensor(s) 964 may be implemented as a small device that may be embedded into the front, rear, sides, and/or corners of the vehicle 900. The LIDAR sensor(s) 964, in such examples, may provide up to a 120-degree horizontal and 35-degree vertical field-of-view, with a 200 m range even for low-reflectivity objects. Front-mounted LIDAR sensor(s) 964 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 900. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 964 may be less susceptible to motion blur, vibration, and/or shock.

The vehicle may further include IMU sensor(s) 966. The IMU sensor(s) 966 may be located at a center of the rear axle of the vehicle 900, in some examples. The IMU sensor(s) 966 may include, for example and without limitation, an accelerometer(s), a magnetometer(s), a gyroscope(s), a magnetic compass(es), and/or other sensor types. In some examples, such as in six-axis applications, the IMU sensor(s) 966 may include accelerometers and gyroscopes, while in nine-axis applications, the IMU sensor(s) 966 may include accelerometers, gyroscopes, and magnetometers.

In some embodiments, the IMU sensor(s) 966 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 966 may enable the vehicle 900 to estimate heading without requiring input from a magnetic sensor by directly observing and correlating the changes in velocity from GPS to the IMU sensor(s) 966. In some examples, the IMU sensor(s) 966 and the GNSS sensor(s) 958 may be combined in a single integrated unit.

The vehicle may include microphone(s) 996 placed in and/or around the vehicle 900. The microphone(s) 996 may be used for emergency vehicle detection and identification, among other things.

The vehicle may further include any number of camera types, including stereo camera(s) 968, wide-view camera(s) 970, infrared camera(s) 972, surround camera(s) 974, long-range and/or mid-range camera(s) 998, and/or other camera types. The cameras may be used to capture image data around an entire periphery of the vehicle 900. The types of cameras used depends on the embodiments and requirements for the vehicle 900, and any combination of camera types may be used to provide the necessary coverage around the vehicle 900. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 9A and FIG. 9B.

The vehicle 900 may further include vibration sensor(s) 942. The vibration sensor(s) 942 may measure vibrations of components of the vehicle, such as the axle(s). For example, changes in vibrations may indicate a change in road surfaces. In another example, when two or more vibration sensors 942 are used, the differences between the vibrations may be used to determine friction or slippage of the road surface (e.g., when the difference in vibration is between a power-driven axle and a freely rotating axle).

The vehicle 900 may include an ADAS system 938. The ADAS system 938 may include a SoC, in some examples. The ADAS system 938 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 960, LIDAR sensor(s) 964, and/or a camera(s). The ACC systems may include longitudinal ACC and/or lateral ACC. Longitudinal ACC monitors and controls the distance to the vehicle immediately ahead of the vehicle 900 and automatically adjust the vehicle speed to maintain a safe distance from vehicles ahead. Lateral ACC performs distance keeping, and advises the vehicle 900 to change lanes when necessary. Lateral ACC is related to other ADAS applications such as LCA and CWS.

CACC uses information from other vehicles that may be received via the network interface 924 and/or the wireless antenna(s) 926 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 900), while the I2V communication concept provides information about traffic further ahead. CACC systems may include either or both I2V and V2V information sources. Given the information of the vehicles ahead of the vehicle 900, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 960, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 960, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 900 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 900 if the vehicle 900 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 960, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 900 is backing up. Some RCTW systems include AEB to ensure that the vehicle brakes are applied to avoid a crash. RCTW systems may use one or more rear-facing RADAR sensor(s) 960, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 900, the vehicle 900 itself must, in the case of conflicting results, decide whether to heed the result from a primary computer or a secondary computer (e.g., a first controller 936 or a second controller 936). For example, in some embodiments, the ADAS system 938 may be a backup and/or secondary computer for providing perception information to a backup computer rationality module. The backup computer rationality monitor may run a redundant diverse software on hardware components to detect faults in perception and dynamic driving tasks. Outputs from the ADAS system 938 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 904.

In other examples, ADAS system 938 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 938 may be fed into the primary computer's perception block and/or the primary computer's dynamic driving task block. For example, if the ADAS system 938 indicates a forward crash warning due to an object immediately ahead, the perception block may use this information when identifying objects. In other examples, the secondary computer may have its own neural network which is trained and thus reduces the risk of false positives, as described herein.

The vehicle 900 may further include the infotainment SoC 930 (e.g., an in-vehicle infotainment system (IVI)). Although illustrated and described as a SoC, the infotainment system may not be a SoC, and may include two or more discrete components. The infotainment SoC 930 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 900. For example, the infotainment SoC 930 may radios, disk players, navigation systems, video players, USB and Bluetooth connectivity, carputers, in-car entertainment, Wi-Fi, steering wheel audio controls, hands free voice control, a heads-up display (HUD), an HMI display 934, a telematics device, a control panel (e.g., for controlling and/or interacting with various components, features, and/or systems), and/or other components. The infotainment SoC 930 may further be used to provide information (e.g., visual and/or audible) to a user(s) of the vehicle, such as information from the ADAS system 938, autonomous driving information such as planned vehicle maneuvers, trajectories, surrounding environment information (e.g., intersection information, vehicle information, road information, etc.), and/or other information.

The infotainment SoC 930 may include GPU functionality. The infotainment SoC 930 may communicate over the bus 902 (e.g., CAN bus, Ethernet, etc.) with other devices, systems, and/or components of the vehicle 900. In some examples, the infotainment SoC 930 may be coupled to a supervisory MCU such that the GPU of the infotainment system may perform some self-driving functions in the event that the primary controller(s) 936 (e.g., the primary and/or backup computers of the vehicle 900) fail. In such an example, the infotainment SoC 930 may put the vehicle 900 into a chauffeur to safe stop mode, as described herein.

The vehicle 900 may further include an instrument cluster 932 (e.g., a digital dash, an electronic instrument cluster, a digital instrument panel, etc.). The instrument cluster 932 may include a controller and/or supercomputer (e.g., a discrete controller or supercomputer). The instrument cluster 932 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 930 and the instrument cluster 932. In other words, the instrument cluster 932 may be included as part of the infotainment SoC 930, or vice versa.

FIG. 9D is a system diagram for communication between cloud-based server(s) and the example autonomous vehicle 900 of FIG. 9A, in accordance with some embodiments of the present disclosure. The system 976 may include server(s) 978, network(s) 990, and vehicles, including the vehicle 900. The server(s) 978 may include a plurality of GPUs 984(A)-984(H) (collectively referred to herein as GPUs 984), PCIe switches 982(A)-982(H) (collectively referred to herein as PCIe switches 982), and/or CPUs 980(A)-980(B) (collectively referred to herein as CPUs 980). The GPUs 984, the CPUs 980, and the PCIe switches may be interconnected with high-speed interconnects such as, for example and without limitation, NVLink interfaces 988 developed by NVIDIA and/or PCIe connections 986. In some examples, the GPUs 984 are connected via NVLink and/or NVSwitch SoC and the GPUs 984 and the PCIe switches 982 are connected via PCIe interconnects. Although eight GPUs 984, two CPUs 980, and two PCIe switches are illustrated, this is not intended to be limiting. Depending on the embodiment, each of the server(s) 978 may include any number of GPUs 984, CPUs 980, and/or PCIe switches. For example, the server(s) 978 may each include eight, sixteen, thirty-two, and/or more GPUs 984.

The server(s) 978 may receive, over the network(s) 990 and from the vehicles, image data representative of images showing unexpected or changed road conditions, such as recently commenced road-work. The server(s) 978 may transmit, over the network(s) 990 and to the vehicles, neural networks 992, updated neural networks 992, and/or map information 994, including information regarding traffic and road conditions. The updates to the map information 994 may include updates for the HD map 922, such as information regarding construction sites, potholes, detours, flooding, and/or other obstructions. In some examples, the neural networks 992, the updated neural networks 992, and/or the map information 994 may have resulted from new training and/or experiences represented in data received from any number of vehicles in the environment, and/or based on training performed at a datacenter (e.g., using the server(s) 978 and/or other servers).

The server(s) 978 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 990, and/or the machine learning models may be used by the server(s) 978 to remotely monitor the vehicles.

In some examples, the server(s) 978 may receive data from the vehicles and apply the data to up-to-date real-time neural networks for real-time intelligent inferencing. The server(s) 978 may include deep-learning supercomputers and/or dedicated AI computers powered by GPU(s) 984, such as a DGX and DGX Station machines developed by NVIDIA. However, in some examples, the server(s) 978 may include deep learning infrastructure that use only CPU-powered datacenters.

The deep-learning infrastructure of the server(s) 978 may be capable of fast, real-time inferencing, and may use that capability to evaluate and verify the health of the processors, software, and/or associated hardware in the vehicle 900. For example, the deep-learning infrastructure may receive periodic updates from the vehicle 900, such as a sequence of images and/or objects that the vehicle 900 has located in that sequence of images (e.g., via computer vision and/or other machine learning object classification techniques). The deep-learning infrastructure may run its own neural network to identify the objects and compare them with the objects identified by the vehicle 900 and, if the results do not match and the infrastructure concludes that the AI in the vehicle 900 is malfunctioning, the server(s) 978 may transmit a signal to the vehicle 900 instructing a fail-safe computer of the vehicle 900 to assume control, notify the passengers, and complete a safe parking maneuver.

For inferencing, the server(s) 978 may include the GPU(s) 984 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### EXAMPLE COMPUTING DEVICE

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### EXAMPLE DATA CENTER

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1133, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1133 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1133. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A. A method comprising: determining one or more first pixels corresponding to one or more locations in an environment depicted in one or more first images generated using a first image sensor of a machine, the one or more first images associated with one or more first instances of time; determining one or more second pixels corresponding to the one or more locations in the environment depicted in one or more second images generated using a second image sensor of the machine, the one or more second images associated with one or more second instances of time; computing, using the one or more first images and the one or more second images, one or more displacement scores indicative of one or more distances between the one or more first pixels and the one or more second pixels; determining, based at least on the one or more displacement scores, one or more object locations of one or more objects in the environment; and performing one or more operations associated with the machine in the environment based at least on the one or more object locations.
B. The method as recited in paragraph A, further comprising: determining, based at least on the one or more displacement scores, that a subset of the one or more first pixels and the one or more second pixels correspond to the one or more objects in the environment; and determining the one or more object locations based at least on one or more pixel locations corresponding to the subset of the one or more first pixels and the one or more second pixels in the one or more first images and the one or more second images.
C. The method as recited in any one of paragraphs A-B, further comprising generating a combination of images by at least combining the one or more first images and the one or more second images, wherein the one or more displacement scores are computed using the combination of images.
D. The method as recited in any one of paragraphs A-C, wherein the one or more first images are associated with one or more first fields of view of the environment and the one or more second images are associated with one or more second fields of view of the environment that at least partially overlap the one or more first fields of view.
E. The method as recited in any one of paragraphs A-D, wherein: the one or more first images correspond to a first set of alternating images of a first temporal series of images generated using the first image sensor; the one or more second images correspond to a second set of alternating images of a second temporal series of images generated using the second image sensor; and the one or more first instances of time are offset from the one or more second instances of time such that a first plurality of timestamps associated with the first temporal series of images are different from a second plurality of timestamps associated with the second temporal series of images.
F. The method as recited in any one of paragraphs A-E, further comprising: determining, based at least on one or more magnitudes of the one or more displacement scores, one or more depths associated with the one or more objects; and determining the one or more object locations of the one or more objects in the environment based at least on the one or more depths.
G. A system comprising: one or more processors to: compute, using an asynchronous series of frames of sensor data generated using an asynchronous set of sensors, one or more displacement scores based at least on one or more first points of a first frame of the asynchronous series of frames and one or more second points of a second frame of the asynchronous series of frames; determine, based at least on the one or more displacement scores, one or more locations of one or more objects in an environment; and cause a machine to perform one or more operations in the environment based at least on the one or more locations of the one or more objects.
H. The system as recited in any paragraph G, the one or more processors further to: generate, using a first sensor of the asynchronous set of sensors, the first frame at a first instance of time; and generate, using a second sensor of the asynchronous set of sensors, the second frame at a second instance of time that is different from the first instance of time.
I. The system as recited in any one of paragraphs G-H, wherein the first frame is associated with a first field of view of the environment and the second frame is associated with a second field of view of the environment different from the first field of view.
J. The system as recited in any one of paragraphs G-I, wherein the sensor data is image data and the sensors are image sensors, the first frame corresponding to a first image frame generated using a first image sensor of the image sensors and the second frame corresponding to a second image frame generated using a second image sensor of the image sensors.
K. The system as recited in any one of paragraphs G-J, the one or more processors further to: determine, using an optical flow algorithm, that the one or more first points of the first frame correspond to the one or more second points of the second frame, wherein the computation of the one or more displacement scores is based at least on the determination that the one or more first points correspond to the one or more second points.
L. The system as recited in any one of paragraphs G-K, the one or more processors further to: compute one or more second displacement scores based at least on the one or more second points of the second frame and one or more third points of a third frame of the asynchronous series of frames, the third frame generated using a same sensor used to generate the first frame; and determine, based at least on the one or more second displacement scores, whether to update the one or more locations of the one or more objects.
M. The system as recited in any one of paragraphs G-L, wherein the one or more displacement scores are indicative of one or more magnitudes of one or more distances between the one or more first points and the one or more second points, the one or more first points and the one or more second points corresponding to one or more same locations in the environment.
N. The system as recited in any one of paragraphs G-M, the one or more processors further to: generate, using a first sensor of the asynchronous set of sensors, a first alternating, temporal series of frames of the sensor data; and generate, using a second sensor of the asynchronous set of sensors, a second alternating, temporal series of frames of the sensor data that is offset from the first alternating, temporal series of frames, wherein the asynchronous series of frames of the sensor data includes at least the first alternating, temporal series of frames and the second alternating, temporal series of frames.
O. The system as recited in any one of paragraphs G-N, the one or more processors further to: compare a first subset of the one or more displacement scores with a second subset of the one or more displacement scores, the first subset corresponding to a first row of at least one of the one or more first points or the one or more second points, the second subset corresponding to a second row of the at least one of the one or more first points or the one or more second points; determine, based at least on the comparison, that the first row of the at least one of the one or more first points or the one or more second points correspond to the one or more objects; and determine the one or more locations of the one or more objects in the environment based at least on a vertical location of the first row with respect to at least one of the first frame or the second frame.
P. The system as recited in any one of paragraphs G-O, the one or more processors further to: compare the one or more displacement scores with one or more baseline displacement scores associated with a driving surface; and determine, based at least on the comparison, that one or more subsets of at least one of the one or more first points or the one or more second points correspond to the one or more objects.
Q. The system as recited in any one of paragraphs G-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; a system implementing one or more optical flow hardware accelerators; or a system implemented at least partially using cloud computing resources.
R. One or more processors comprising: processing circuitry to evaluate, within a simulation rendered using one or more light transport simulation algorithms, one or more optical flow algorithms for detecting objects using at least one asynchronous pair of images depicting a virtual environment from different perspectives and generated using an asynchronous pair of virtual image sensors of a virtual machine as the virtual machine traverses the simulated environment.
S. The one or more processors as recited in paragraph R, wherein the simulation is generated, at least in part, using a three-dimensional (3D) content collaboration platform for 3D assets.
T. The one or more processors as recited in any one of paragraphs R-S, wherein the 3D content collaboration platform for 3D assets uses universal scene descriptor (USD) data for managing one or more attributes of a simulated environment associated with the simulation.

What is claimed is:

1. A method comprising:
determining one or more first pixels corresponding to one or more locations in an environment depicted in one or more first images generated using a first image sensor of a machine, the one or more first images associated with one or more first instances of time;
determining one or more second pixels corresponding to the one or more locations in the environment depicted in one or more second images generated using a second image sensor of the machine, the one or more second images associated with one or more second instances of time;
computing, using the one or more first images and the one or more second images, one or more displacement scores indicative of one or more distances between the one or more first pixels and the one or more second pixels;
determining, based at least on the one or more displacement scores, one or more object locations of one or more objects in the environment; and
performing one or more operations associated with the machine in the environment based at least on the one or more object locations.

2. The method of claim 1, further comprising:
determining, based at least on the one or more displacement scores, that a subset of the one or more first pixels and the one or more second pixels correspond to the one or more objects in the environment; and
determining the one or more object locations based at least on one or more pixel locations corresponding to the subset of the one or more first pixels and the one or more second pixels in the one or more first images and the one or more second images.

3. The method of claim 1, further comprising generating a combination of images by at least combining the one or more first images and the one or more second images, wherein the one or more displacement scores are computed using the combination of images.

4. The method of claim 1, wherein the one or more first images are associated with one or more first fields of view of the environment and the one or more second images are associated with one or more second fields of view of the environment that at least partially overlap the one or more first fields of view.

5. The method of claim 1, wherein:
the one or more first images correspond to a first set of alternating images of a first temporal series of images generated using the first image sensor;
the one or more second images correspond to a second set of alternating images of a second temporal series of images generated using the second image sensor; and
the one or more first instances of time are offset from the one or more second instances of time such that a first plurality of timestamps associated with the first temporal series of images are different from a second plurality of timestamps associated with the second temporal series of images.

6. The method of claim 1, further comprising:
determining, based at least on one or more magnitudes of the one or more displacement scores, one or more depths associated with the one or more objects; and
determining the one or more object locations of the one or more objects in the environment based at least on the one or more depths.

7. A system comprising:
one or more processors to:
compute, using an asynchronous series of frames of sensor data generated using an asynchronous set of sensors, one or more displacement scores based at least on one or more first points of a first frame of the asynchronous series of frames and one or more second points of a second frame of the asynchronous series of frames;
determine, based at least on the one or more displacement scores, one or more locations of one or more objects in an environment; and
cause a machine to perform one or more operations in the environment based at least on the one or more locations of the one or more objects.

8. The system of claim 7, the one or more processors further to:
generate, using a first sensor of the asynchronous set of sensors, the first frame at a first instance of time; and
generate, using a second sensor of the asynchronous set of sensors, the second frame at a second instance of time that is different from the first instance of time.

9. The system of claim 7, wherein the first frame is associated with a first field of view of the environment and the second frame is associated with a second field of view of the environment different from the first field of view.

10. The system of claim 7, wherein the sensor data is image data and the sensors are image sensors, the first frame corresponding to a first image frame generated using a first image sensor of the image sensors and the second frame corresponding to a second image frame generated using a second image sensor of the image sensors.

11. The system of claim 7, the one or more processors further to:
determine, using an optical flow algorithm, that the one or more first points of the first frame correspond to the one or more second points of the second frame,
wherein the computation of the one or more displacement scores is based at least on the determination that the one or more first points correspond to the one or more second points.

12. The system of claim 7, the one or more processors further to:
compute one or more second displacement scores based at least on the one or more second points of the second frame and one or more third points of a third frame of the asynchronous series of frames, the third frame generated using a same sensor used to generate the first frame; and
determine, based at least on the one or more second displacement scores, whether to update the one or more locations of the one or more objects.

13. The system of claim 7, wherein the one or more displacement scores are indicative of one or more magnitudes of one or more distances between the one or more first points and the one or more second points, the one or more first points and the one or more second points corresponding to one or more same locations in the environment.

14. The system of claim 7, the one or more processors further to:
generate, using a first sensor of the asynchronous set of sensors, a first alternating, temporal series of frames of the sensor data; and
generate, using a second sensor of the asynchronous set of sensors, a second alternating, temporal series of frames of the sensor data that is offset from the first alternating, temporal series of frames,
wherein the asynchronous series of frames of the sensor data includes at least the first alternating, temporal series of frames and the second alternating, temporal series of frames.

15. The system of claim 7, the one or more processors further to:
compare a first subset of the one or more displacement scores with a second subset of the one or more displacement scores, the first subset corresponding to a first row of at least one of the one or more first points or the one or more second points, the second subset corresponding to a second row of the at least one of the one or more first points or the one or more second points;
determine, based at least on the comparison, that the first row of the at least one of the one or more first points or the one or more second points correspond to the one or more objects; and
determine the one or more locations of the one or more objects in the environment based at least on a vertical location of the first row with respect to at least one of the first frame or the second frame.

16. The system of claim 7, the one or more processors further to:
compare the one or more displacement scores with one or more baseline displacement scores associated with a driving surface; and
determine, based at least on the comparison, that one or more subsets of at least one of the one or more first points or the one or more second points correspond to the one or more objects.

17. The system of claim 7, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center;
a system implementing one or more optical flow hardware accelerators; or
a system implemented at least partially using cloud computing resources.

18. One or more processors comprising:
processing circuitry to evaluate, within a simulation rendered using one or more light transport simulation algorithms, one or more optical flow algorithms for detecting objects using at least one asynchronous pair of images depicting a virtual environment from different perspectives and generated using an asynchronous pair of virtual image sensors of a virtual machine as the virtual machine traverses the simulated environment.

19. The one or more processors of claim 18, wherein the simulation is generated, at least in part, using a three-dimensional (3D) content collaboration platform for 3D assets.

20. The one or more processors of claim 19, wherein the 3D content collaboration platform for 3D assets uses universal scene descriptor (USD) data for managing one or more attributes of a simulated environment associated with the simulation.
